(19) United States
(12) Patent Application Publication
(10) Pub. No.: US 2023/0354049 A1
(43) Pub. Date: Nov. 2, 2023

(54) ELECTRONIC DEVICE AND METHOD IN A WIRELESS COMMUNICATION

(71) Applicant: Sony Group Corporation, Tokyo (JP)

(72) Inventor: Zhong TIAN, Beijing (CN)

(73) Assignee: Sony Group Corporation, Tokyo (JP)

(21) Appl. No.: 18/044,995

(22) PCT Filed: Sep. 26, 2021
(86) PCT No.: PCT/CN2021/120545

§ 371 Date: Mar. 13, 2023

(30) Foreign Application Priority Data
Sep. 29, 2020 (CN) 202011048351.1

(51) Int. Cl. H04W 16/16; H04W 12/06

(52) U.S. Cl. CPC H04W 16/16; H04W 12/06

(57) ABSTRACT

The present disclosure relates to electronic device and method in a wireless communication system. An electronic device of a wireless communication system for purchasing wireless communication resources has an associated communication coverage which intersects with communication coverage of at least one neighboring electronic device. The electronic device comprises a processing circuit configured to determine a specific number of neighboring electronic devices in the at least one neighboring electronic device for purchasing wireless communication resources therefrom, and to purchase wireless communication resources from the specific number of neighboring electronic devices on the basis of the sizes of communication coverage intersection areas between the electronic device and the specific number of neighboring electronic devices.

### CROSS-REFERENCE OF RELATED APPLICATIONS

The present application claims the benefit of priority to CN application No. 202011048351.1 filed on Sep. 29, 2020, which is incorporated by reference herein in its entity.

### FIELD OF THE INVENTION

The present disclosure relates to electronic device and method in a wireless communication system, and particularly, to electronic device and method in a wireless communication system for spectrum resource management.

### BACKGROUND

With the development and wide application of mobile Internet technology, more and more devices have been connected to the mobile network, and new services and applications emerge in endlessly. In order to meet people's communication requirements, the fifth-generation mobile communication technology (briefly referred to as 5G or 5G technology) has become a hot topic of discussion and research in the communication industry and academia. The fifth-generation mobile communication technology is the latest generation of cellular mobile communication technology, and its performance targets are high data rate, reduced latency, energy saving, cost reduction, increased system capacity and large-scale device connection. 5G has three typical application scenarios: Enhanced Mobile Broadband (eMBB), High Reliability and Low Latency (uRLLC), and Massive Internet of Things (mMTC), and has fundamental characteristics of high speed, low latency, wide connection, ultra sense heterogeneous network, software-defined network (SDN) and network function virtualization (NFV), new network architecture.

With the development of the mobile Internet, the number of networked users and communication demands rapidly develop, the surge of mobile data traffic will bring severe challenges to the network. In particular, the growth of data traffic will inevitably increase further demands for communication resources, and in the case of limited communication resources, higher requirements are put forward for the efficient usage of communication resources.

Unless otherwise stated, it should not be assumed that any of the methods described in this section become prior art only because they are included in this section. Similarly, unless otherwise stated, the problems recognized about one or more methods should not be assumed to be recognized in any prior art on the basis of this section.

### DISCLOSURE OF THE INVENTION

The present disclosure provides electronic device and method in a wireless communication system, which can improve communication resource allocation/sharing in the wireless communication system, enhance communication resource utilization efficiency, and achieve high security.

One aspect of the present disclosure relates to an electronic device in a wireless communication system for purchasing wireless communication resources, the electronic device has an associated communication coverage which intersects with the communication coverage of at least one neighboring electronic device, the electronic device comprises a processing circuit configured to determine a specific number of neighboring electronic devices in the at least one neighboring electronic device for purchasing wireless communication resources therefrom; and purchase the wireless communication resources from the specific number of neighboring electronic devices on the basis of the sizes of communication coverage intersection areas between the electronic device and the specific number of neighboring electronic devices.

Another aspect of the present disclosure relates to an electronic device in a wireless communication system for selling wireless communication resources, the electronic device has an associated communication coverage, the electronic device includes a processing circuit configured to receive bids from at least one neighboring electronic device for wireless communication resources of the electronic device, the at least one neighboring electronic device having communication coverage intersecting with that of the electronic device; and select a specific electronic device in the at least one neighboring electronic device for selling wireless communication resources thereto.

Still another aspect of the present disclosure relates to a method for an electronic device in a wireless communication system for purchasing wireless communication resources, the electronic device has an associated communication coverage which intersects with the communication coverage of at least one neighboring electronic device, and the method comprises determining a specific number of neighboring electronic devices in the at least one neighboring electronic device for purchasing wireless communication resources therefrom; and purchasing wireless communication resources from the specific number of neighboring electronic devices on the basis of the sizes of communication coverage intersection areas between the electronic device and the specific number of neighboring electronic devices.

Yet another aspect of the present disclosure relates to a method for an electronic device in a wireless communication system for selling wireless communication resources, the electronic device has an associated communication coverage, and the method comprises receiving bids from at least one neighboring electronic device for wireless communication resources of the electronic device, the at least one neighboring electronic device having communication coverage intersecting with that of the electronic device; and selecting a specific electronic device in the at least one neighboring electronic device for selling wireless communication resources thereto.

Yet another aspect of the present disclosure relates to a non-transitory computer-readable storage medium storing executable instructions thereon, and the executable instructions, when executed by a processor, cause the processor to implement methods as described herein.

In still another aspect, there is provided a wireless communication device. In an embodiment, the wireless communication device comprises a processor and a storage device having stored executable instructions thereon which, when executed by the processor, cause the processor to implement methods as described herein.

In yet another aspect, there is provided an apparatus comprising means for performing methods as described herein.

The foregoing summary is provided to summarize some exemplary embodiments in order to provide a basic understanding of aspects of the subject matter described herein. Accordingly, the above-described features are examples only and should not be construed as narrowing the scope or spirit of the subject matter described herein in any way. Other features, aspects and advantages of the subject matter described herein will become apparent from the following description of exemplary embodiments with reference to the accompanying drawings.

### DESCRIPTION OF THE DRAWINGS

Hereinafter, the above and other objects and advantages of the present disclosure will be further described in combination with specific embodiments with reference to the accompanying drawings. In the drawings, like terms will be denoted by like reference numerals.

FIG. 1 schematically illustrates a communication scenario according to the present disclosure.

FIG. 2 schematically illustrates a signaling interaction diagram of resource transactions according to the present disclosure.

FIG. 3 is a block diagram schematically illustrating an electronic device in a wireless communication system for purchasing wireless communication resources according to an embodiment of the present disclosure.

FIG. 4 schematically illustrates calculation of coverage intersection area according to the present disclosure.

FIG. 5 is a block diagram schematically illustrates an electronic device in a wireless communication system for selling wireless communication resources according to an embodiment of the present disclosure.

FIG. 6 is a flowchart schematically illustrating a method for an electronic device in a wireless communication system for purchasing wireless communication resources according to an embodiment of the present disclosure.

FIG. 7 is a flowchart schematically illustrating a method for an electronic device in a wireless communication system for selling wireless communication resources according to an embodiment of the present disclosure.

FIG. 8 is a schematic diagram of an exemplary resource reallocation operation according to the present disclosure.

FIG. 9 schematically illustrates a block diagram of an exemplary structure of a personal computer as an information processing device that can be employed in an embodiment of the present disclosure.

FIG. 10 is a block diagram illustrating a first example of a schematic configuration of an gNB to which the technology of the present disclosure can be applied.

FIG. 11 is a block diagram illustrating a second example of a schematic configuration of an gNB to which the technology of the present disclosure can be applied.

FIG. 12 is a block diagram illustrating an example of a schematic configuration of a smartphone to which the technology of the present disclosure can be applied; and

FIG. 13 is a block diagram illustrating an example of a schematic configuration of a vehicle navigation device to which the technology of the present disclosure can be applied.

Although embodiments of this disclosure may be susceptible to various modifications and alternative forms, the embodiments of the present disclosure are shown by way of example in the drawings and are described in detail herein. It should be understood that the drawings and detailed description thereof are not intended to limit the embodiments to the particular forms disclosed, on the contrary, the intention is to cover all modifications, equivalents, and alternatives falling within the spirit and scope of the claims.

### DETAILED DESCRIPTION OF PREFERRED EMBODIMENTS

Hereinafter, exemplary embodiments of the present disclosure will be described with reference to the accompanying drawings. For the sake of clarity and conciseness, not all features of the embodiments are described in the description. However, it should be understood that many implementation-specific settings must be made during the implementation of the embodiments in order to achieve specific goals of developers, for example, to meet those constraints related to equipment and business, and these constraints may vary with different implementations. In addition, it should be understood that although the development work may be very complicated and time-consuming, it is only a routine task for those skilled in the art who benefit from this disclosure.

Here, it should also be noted that in order to avoid obscuring the present disclosure by unnecessary details, only processing steps and/or equipment structures closely related to the schemes at least according to the present disclosure are shown in the drawings, while other details not closely related to the present disclosure are omitted. It should be noted that similar reference numerals and letters indicate similar items in the drawings, and therefore, once an item is defined in one drawing, there is no need to discuss it for subsequent drawings.

In this disclosure, the terms “first”, “second” and the like are only used to distinguish elements or steps, and are not intended to indicate time sequence, preference or importance.

In the current communication resource management (such as spectrum management), it is usually to pre-allocate communication resources for the base station or other resource utilization equipments in the wireless communication system, so that during the communication, the base station will utilize the pre-allocated communication resources to communicate with a base station or other devices, or provide a service to a user visiting the base station, and the allocated resource remains substantially constant during the communication. However, in the usage process, it usually occurs that the communication resources authorized for some base stations cannot meet their usage requirements, while the communication resources authorized for other base stations may be idle, which adversely affects the system performance, and causes waste of communication resources. This is especially prominent when communication resources are limited.

In order to alleviate tension of communication resources, fine management of communication resources can be carried out in the 5G network, so as to realize sharing of communication resources in different frequency bands, exchanging and utilization of communication resources between different base stations/devices, and various networks (such as 5G network spectrum, Internet of Things vertical industry spectrum, WIFI license-free spectrum) dynamically sharing communication resources.

Usually, in a region, it is allowed to use specific spectrum resources to build a private network, so that in the region, a base station can provide services for users in the region. There will be multiple base stations distributed in this region, and each base station will have different spectrum resources. If during certain periods of time, some base stations need not to communicate or need not be allocated such many spectrum resources for communication, a good idea is to allocate idle spectrum resources to other base stations that are in urgent need of spectrum resources, so that the spectrum efficiency of the entire system can be greatly improved. It should be noted that in addition to meeting the requirements of all parties, the sharing and allocation of communication resources should also consider information security.

The present disclosure proposes utilizing a block chain technology to realize communication resource management in a communication system, especially by using the block chain technology to realize dynamic management and allocation of resources among devices in a wireless communication system that need to use resources for communication, for example, devices that need to use communication resources to provide services, transmit data, etc., especially such as base stations, thereby optimizing resource utilization efficiency, improving security, and realizing improvement of communication services.

As an emerging technology, blockchain is essentially a digital distributed ledger with the characteristics of decentralization, trustlessness, non-tampering, encryption security and openness. In a blockchain network, there is no core node, and all nodes comply with established rules. In the context of the present disclosure, by using the blockchain technology in the 5G communication system, it is possible to effectively manage sharing allocation and use of various frequency spectrums by various networks and various terminals. For example, blockchain can help 5G to solve problems such as user privacy information security, online transaction trust establishment, virtual intellectual property protection, etc., so as to deal with resource allocation/sharing while also improving the security of information transmission. In this disclosure, the term “blockchain technology” includes, but not limited to, technologies such as distributed storage, peer-to-peer network, consensus mechanisms, and encryption algorithms, and so on. Detailed description will not be given here.

In the present disclosure, dynamic allocation/sharing of resources in a wireless communication system can be implemented by means of block resource transactions. That is to say, during the communication, by means of transaction activities between different communication devices, including purchase, sale and transaction approval of resources, the dynamic reallocation of communication resources among communication devices can be realized, so that the allocation and usage of resources can be more suitable for application requirements of system devices, improve resource utilization efficiency, and improve communication performance.

In particular, resource transactions are based on the blockchain technology, and communication devices in the system serve as nodes that can participate in resource transactions. Devices that can request to be allocated (also referred to as purchase) additional resources for communication/service provision and that can share their own idle resources, e.g. network access points (APs), base stations, etc., can serve as both parties of the resource transactions, nodes seeking to purchase resources (also known as purchaser nodes) apply for resource transactions to nodes selling resources (also known as seller nodes) through bidding, and seller nodes select the purchaser nodes to traded according to rules, and the accounting nodes in the system can summarize all transactions, and then package and send unauthenticated blocks to each node for authentication. If a certain transaction is confirmed as a legal transaction, it will be recorded in a newly generated block by the accounting node and notified to the nodes in the system.

According to embodiments of the present disclosure, the communication resources in the wireless communication system mentioned in the present disclosure may refer to any of various resources that can be used by devices in the wireless communication system to communicate and/or provide services, such as physical resources, channel resources, and time-frequency resources, etc., and these resources can take various forms and be used by devices in the wireless communication system in various appropriate ways, which will not be described in detail here.

According to the present disclosure, when multiple devices in the communication system perform dynamic allocation/transaction of communication resources based on the blockchain technology, the multiple devices can utilize various appropriate communication manners for information transmission thereamong, especially information about transaction and control information need to be exchanged between different devices, according to embodiments of the present disclosure, such information exchange can be achieved through a public network, such as WiFi or 5G. For example, all devices can connect to the public network, such as WiFi or cellular network, for implementation of information exchange.

According to another embodiment of the present disclosure, it may also be implemented by an ad hoc network provided in the present disclosure. For example, a frequency band can be selected from available spectrum resources as a public channel, then an ad-hoc network of devices is established, and appropriate routing protocols can be employed to implement information transmission and exchanging between different devices.

In a wireless ad hoc network, node-to-node data transmission generally requires multi-hop routing. Ad-hoc routing protocols can generally be classified into geolocation-assisted routing and non-geolocation-assisted routing. Among them, non-geolocation-assisted routing can be further divided into hierarchical routing and flat routing. The levels of nodes in the hierarchical routing are not equal, usually, all nodes in the area will be divided into multiple clusters, the central node of each cluster is responsible for forwarding data of nodes, while the ordinary nodes in the cluster only need to communicate data with the central node of the cluster. On the other hand, the level of each node in the flat routing is equal. Equal routing can be divided into a table-driven routing protocol and a reactive routing protocol. In the table-driven routing, each node needs to maintain paths to all other nodes, and the overhead of routing protocols are large, typical protocols include DSDV (Destination sequenced distance vector), CGSR (cluster head gateway switching routing) and WRP (Wireless Routing Protocol, Wireless Routing Protocol). In the reactive routing, a routing algorithm that searches for routes will be activated only when data needs to be sent. When sending a message to a destination node, the source node initiates the routing search process in the network to find corresponding paths, the overhead is small but the delay in datagram transmission is larger. Specific algorithms include DSR (Dynamic Source Routing), AODV (Ad hoc on Demand Vector Routing) and TOAR (Temporally Ordered Routing Algorithm).

Typically, a wireless communication system according to the present disclosure that performs resource sharing in a resource transaction mode can include a resource purchase end, a resource sale end, and a transaction accounting end for communication resources. In this disclosure, a “resource purchase end” of a wireless communication system has the full breadth of its usual meaning, generally indicating a device in a communication system that requires additional communication resources to communicate and/or provide services, and a “resource sale end” of a wireless communication system” has the full breadth of its usual meaning, generally indicating a device in a communication system that can provide additional idle communication resources to be used by other devices, and a “transaction accounting end” of a wireless communication system has the full breadth of its usual meaning, generally indicating a device in the communication system that summarizes and sends the transaction concluded between the resource purchase end and the resource sale end to all parties in the communication system for authentication. It should be noted that the aforementioned resource purchase end, resource sale end, transaction accounting end, etc. are mainly classified/named according to their respective roles/functions in the resource transaction process. In an actual wireless communication system, their corresponding devices can separate from each other, or can also combine with each other. For example, a device in a wireless communication system may be a device at the resource purchase end or a resource sale end, and it may also be a device at the transaction accounting end.

The resource purchase end, resource sale end, and transaction accounting end in the communication system may correspond to same types of devices in the communication system, such as access points (APs), base stations, etc. in the communication system. In this disclosure, the term “base station” has the full breadth of its usual meaning, and includes at least a wireless communication station that is used as part of a wireless communication system or radio system for communication. As an example, the base station may be, for example, an eNB following the 4G communication standard, a gNB following the 5G communication standard, a remote radio head-end, a wireless access point, an unmanned aerial vehicle control tower, or a communication device performing similar functions.

The following will take AP as an example to describe exemplary implementation of embodiments of the present disclosure. However, it should be noted that the AP is only exemplary, and the resource purchase end, resource sale end, and transaction accounting end of the present disclosure are not so limited, and they may also correspond to the same type of other devices that can utilize resources for communication, it may even correspond to different types of devices that can perform communication by using resources, as long as the resources that they use can be shared.

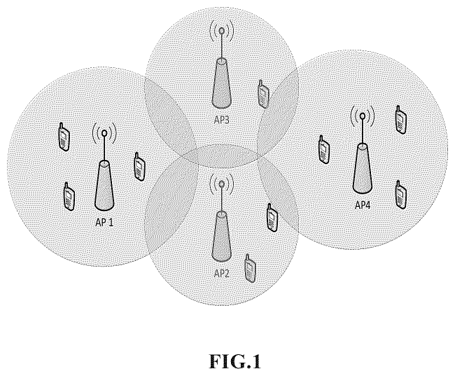

FIG. 1 illustrates a communication scenario according to the present disclosure. This communication scenario includes multiple APs, such as AP1 to AP4, each AP has its own coverage, indicated by a corresponding dotted circle, and can provide network services for terminal devices within its coverage. In this disclosure, a terminal device may refer to a terminal device that communicates as a part of a wireless communication system or a radio system, especially a client device (UE) of a wireless communication system, such as a vehicle or a vehicle communication device in V2X, mobile devices in cell communication, robots in similar application scenarios, etc., or their components.

Different APs have different coverages, and thus the numbers of terminals that can be carried/served in their coverages may be also different. Generally, the more the number of terminals to be carried in the coverage of an AP, the greater the demand of the AP for spectrum resources. For example, the number of terminals within the coverage of AP1 is large, and AP1 has a greater demand for spectrum resources, and the number of terminals within the coverage of AP3 is relatively small, so AP3 has a smaller demand for spectrum resources. There will be overlapping/intersection between the coverages of various APs, as shown by the overlapping or intersection sections between the dotted circles in the figure.

The system scenario allows usage of private network spectrum resources or unlicensed spectrum resources, such as the available spectrum resources specified in CBRS or white spectrum resources in TVWS. If the existing spectrum resources of an AP per se cannot meet the communication requirements of all the terminals it carries, it can seek to trade with surrounding APs for obtaining new spectrum resources.

According to an embodiment of the present disclosure, in the transaction system, a purchaser AP that wants to purchase resources proposes a transaction to a sale AP that can sell resources for dynamic resource allocation and sharing. It should be noted that a device in a communication system can be used as either a device on the resource purchase side or a device on the resource sale side, which usually depends on the communication requirements/resource usage of the device. In particular, the AP will estimate the demand for spectrum resources based on the communication requirements in the coverage. If more spectrum resources are required, the AP will be a purchaser AP; if it have redundant spectrum resources idle, the AP will be a seller AP.

According to an embodiment of the present disclosure, the purchaser AP determines the seller AP in consideration of communication interference. In particular, the determination of the seller AP is based on communication interference. Among them, the purchaser AP would seek to purchase spectrum resources from neighboring APs that have converage intersecting with that of the purchaser AP, this is because an AP using spectrum resources in the intersection ranges will cause interference to the communications of surrounding APs, therefor, by reallocation of resources between APs with intersection coverages, resource allocation between neighboring APs can be effectively balanced. Moreover, such resource reallocation is mainly limited to APs with intersecting coverages, so that the impact of resource allocation and utilization on the system can be reduced.

As an example, in the communication scenario shown in FIG. 1, the number of terminals within the coverage of AP1 is large, but the existing spectrum resources of AP1 are insufficient in the process of providing services to terminals, and the number of terminals served by AP3 whose coverage intersects with that of AP1 is relative small, and there may exist potentially idle spectrums therein. Therefore, AP1 can seek to purchase spectrum resources from AP3 to meet its own communication requirements.

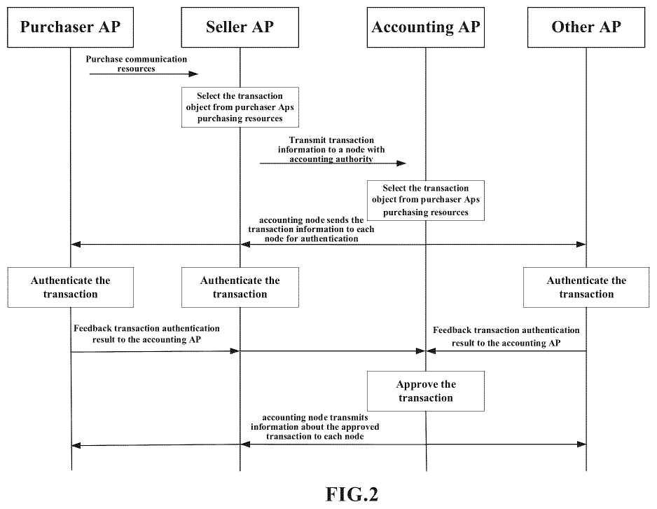

In the communication scenario according to the present disclosure, the blockchain technology can be used for spectrum transaction between APs, and the flow of the whole scheme is shown in FIG. 2. FIG. 2 schematically shows a signaling interaction diagram of resource transaction according to the present disclosure.

Among them, AP1 indicates a resource purchase end in the system, that is, the purchaser AP, for example, its own spectrum resources cannot meet the requirements of communication services due to large number of terminals in its coverage. AP2 indicates a resource sale end in the system, which belongs to a neighboring node of the resource purchase end and has a coverage intersecting with that of the resource purchase end, for example, it has redundant spectrum resources available for sale due to the small number of terminals in its coverage. AP3 indicates a transaction accounting end in the system, which is a selected node with accounting authority, which can summarize all transactions, and then package and send unauthenticated blocks to each node for authentication, for example, at least send unauthenticated blocks to nodes as both parties of the transaction, even nodes related to the resources involved in the transaction but not participating in the transaction, for example, nodes whose communication may be interfered by the spectrum resources to be traded.

In a system scenario, multiple APs need to exchange information to achieve spectrum transaction in the entire scenario. In the present disclosure, information exchange between APs may be implemented in an appropriate manner. In particular, considering that in the system scenario of the present disclosure, respective APs are relatively independent from each other and have limited coverages, information exchange between APs can be implemented by using an external network (for example, a central external network), or by using an ad hoc network based on an existing common channel. As an example, one way is that all APs access to a common network, such as WiFi or a cellular network, to complete the task of information exchange. As another example, another way is to select a frequency band from available spectrum resources as a common channel, then establish an ad-hoc network of APs, and use a suitable routing protocol to implement information transmission between different APs. For example, table-driven DSDV, CGSR, and WRP protocols can be used, and reactive routing DSR, AODV, and TOAR can also be used. The determination of information exchange manner can be broadcasted by the AP, or can be informed to each AP by other control devices in advance. It will not be described in detail here.

The accounting node can be selected from APs in the communication scenario in various appropriate ways, and in particular, can be based on the information exchange network employed among the APs. According to an embodiment, if all APs use a common network such as WiFi or cellular networks for information exchange, each AP can use traditional PoW or PoS mechanisms to compete for the accounting authority, which is well known in the blockchain technology and will not be repeated in detail here. According to another embodiment, if all APs use an ad-hoc network based on a common channel for communication, a method for determining the accounting-authority AP having the shortest routing path may be used. Specifically, a shortest path from a certain AP to each of the other APs in the communication scenario may be calculated, and these shortest paths are summed to obtain the sum of the shortest paths from the certain AP to other APs. Then, the shortest path sums of respective nodes are compared, and a node whose shortest path sum is minimal is selected as the node with the accounting authority. Calculation of the shortest paths from this node to all other nodes can be realized by various appropriate methods, such as Dijkstra algorithm. Therefore, an appropriate AP can be selected among the APs in the communication scenario as the accounting node, and the accounting node may even be the seller AP or the purchaser AP itself. After the accounting node in the communication scenario is determined, it can be notified to APs in the communication scenario in an appropriate way, for example, it can be determined when the communication network is established and then notified to APs in the communication network by broadcasting, or can be notified in other manners, which will not be described in detail here.

In addition, it should be noted that the purchaser AP and the seller AP are not fixed, but may be adjusted dynamically as the transaction proceeds. That is to say, the AP will adjust its status of purchasing or selling resources according to the number of terminals that it needs to serve and its own resource status. In particular, after the purchase AP obtains additional communication resources through transactions, if during the subsequent communication process, the number of terminals within its coverage decreases and its own resources become idle, the purchase AP may change from the purchase party to the sale party. On the contrary, after the sale AP sells its idle communication resources to be used by other APs through transactions, if in the subsequent communication process, the number of terminals within its coverage increases and its own resources are insufficient, the sale AP may change from the sale party to the purchase party for requesting additional communication resources.

In the interaction process of spectrum transaction according to the present disclosure, firstly, the purchaser AP bids to multiple seller APs with coverages intersected with that of the purchaser AP according to demand. Bid-related information may include identification information of the purchaser AP, the amount of resources required by the purchaser, the bid price of the purchaser AP for resources, and so on, which are transmitted to the seller AP. The information can be represented in any appropriate format, for example, the information can be a data packet, the contents of which can occupy corresponding fields, and can be transmitted in any appropriate way, which will not be described in detail here.

After receiving the bid from the purchaser AP, the seller AP selects a transaction object from multiple purchaser APs according to a specific rule, determines the spectrum sale price, and sends the transaction information to the purchaser AP and an AP with the accounting authority. The specific rule may refer to the seller AP selecting an appropriate purchaser AP according to various criteria, such as according to the bid price, the degree of correlation between the purchaser and seller APs, and so on.

The AP with the accounting authority summarizes all transaction information and forms an unauthenticated new block, and sends it to all relevant APs for authentication. All relevant APs include at least APs participating in resource transactions, and may even include APs whose operation may be interfered by the communication resource transaction even though they do not participate in the transaction, or even all APs included in the communication scenario.

All relevant APs authenticate the block sent by the AP with the accounting authority, and feedback the authentication result to the AP with the accounting authority. As an example, an AP participating in the authentication classifies all transactions, and then authenticates the transactions to which it relates. Then the result is fed back to the AP with the accounting authority.

The AP participating in the authentication can adopt an appropriate authentication manner, and in particular, adopt a corresponding authentication method according to its association with the resource transaction, especially the degree of influence caused by the resource transaction.

According to an example, the AP participating in the authentication can be a participant in a resource transaction, for example as a purchaser or a seller of this transaction. In this way, when performing authentication, the AP mainly checks information of both parties in the transaction, for example, the bandwidths of the spectrum resources to be traded, the transaction price and other information. For example, information sent by the accounting node can be compared with transaction information. If the information is correct, the transaction is approved, and the authentication result is fed back to the accounting node.

According to another example, an AP participating in authentication may be an AP that may be influenced by resource transactions. In particular, the AP may be the following AP: after the resource transaction occurs, the coverage of the AP itself intersects with the coverage of the purchaser AP, and the spectrum resource purchased by the purchaser AP is also the spectrum resource used by the AP. Such resource transaction may interfere with the communication of the AP serving the terminals within its own coverage. In this case, the AP participating in the authentication can perform authentication based on the degree of interference. If the interference exceeds the AP's interference tolerance, the transaction is not approved. As an example, the AP participating in the authentication may calculate the intersection area between the coverage of the AP and the coverage of the purchaser AP, and if the intersection area is less than a certain threshold, the transaction is approved; otherwise, the transaction is not approved. The threshold here can be set based on the degree of tolerance to interference.

According to another example, an AP participating in authentication may be an AP that may not be affected by resource transactions. For example, before and after the transaction occurs, communications within the coverage of the AP will not be affected by any interference. Therefore, the AP need not to authenticate the transaction. As another example, a waiver may be fed back as the authentication result, and such authentication result will not affect the judgement whether the transaction is successful or not.

After receiving the authentication results from the APs participating in the authentication, the AP with the accounting authority can determine a legal transaction according to the rules, writes the legal transaction into a new block, and distributes it to each AP, thus the resource transaction ends. A legal transaction may refer to an approved/licensed resource transaction, and the determination of a legal transaction may be performed in various manners in the blockchain technology, which will not be described in detail here.

This disclosure proposes to use the blockchain technology to reasonably allocate spectrum resources for multiple APs in the scenario, and to build a differentiated Ad hoc private network according to the actual communication requirements of APs in different regions in the scenario. Among them, the AP will adjust the demand for communication resources according to the communication requirements, and then purchase or sell communication resources from or to neighboring APs, so that the resources of each AP can be dynamically adjusted so as to improve resource utilization efficiency. And all transactions need to be authenticated by the relevant APs, and then the accounting AP forms a new block therefrom and distributes it to each AP for recording, so that the use of blockchain can improve the security of information interaction. Therefore, based on the blockchain technology, this disclosure conducts reasonable transactions of spectrum resources for multiple APs in the system scenario to adapt to the requirements of data traffic in different regions, thereby improving the overall utilization efficiency of communication resources in the entire system scenario.

Embodiments according to the present disclosure will be described below with reference to the accompanying drawings. In particular, electronic devices and methods related to resource purchase, resource sale, and transaction confirmation in a wireless communication system will be described respectively. Among them, electronic devices related to resource purchase, electronic devices related to resource sale, and electronic devices related to transaction confirmation can communicate through a public network or through an ad hoc network.

Resource Purchase

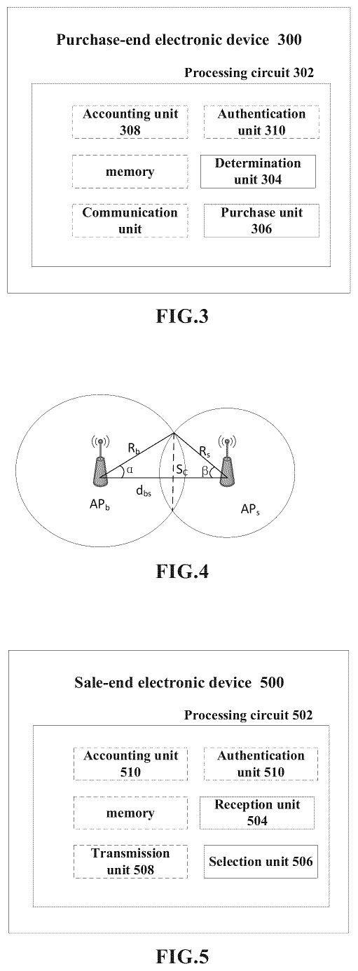

An exemplary electronic device in a wireless communication system for purchasing wireless communication resources according to an embodiment of the present disclosure will be described below. FIG. 3 shows an exemplary electronic device 300 in a wireless communication system for purchasing wireless communication resources, according to an embodiment of the present disclosure, the electronic device has an associated communication coverage which intersects with that of at least one neighboring electronic device.

The electronic device 300 includes a processing circuit 302 configured to determine a specific number of neighboring electronic devices in the at least one neighboring electronic device for purchasing wireless communication resources therefrom; and purchase the wireless communication resources from the specific number of neighboring electronic devices on the basis of the sizes of communication coverage intersection areas between the electronic device and the at specific number of neighboring electronic devices.

It should be noted that the electronic device may correspond to a resource purchase end in the wireless communication system in the communication scenario, which may be the resource purchase end device (such as an access point, a base station, etc. in the communication system) itself, or be an electronic device used in conjunction with the resource purchase end device.

According to one embodiment, the wireless communication resources to be purchased by the electronic device depend on communication requirements within the coverage of the electronic device. In particular, the amount of wireless communication resources to be purchased depends on the number of terminals within the coverage of the electronic device, and additionally may also depend on the number of terminals served by each unit of communication resources. It should be noted that the coverage of an electronic device can be informed by the system before the communication starts, and usually remains unchanged during the communication. The number of terminals within the coverage can be periodically detected and updated by the electronic device during communication, for example, the electronic device can actively detect the number of terminals, or automatically update the number of terminals when the terminals are connected to the electronic device.

As an example, assuming that communication resources are in unit of basic bandwidth unit, and the number of terminals that can be served by a basic bandwidth unit is pre-determined, then by determining the number of terminals within the coverage of the AP, the required number of bandwidth units can be known, so as to judge whether the spectrums owned by the current AP can satisfy the requirement. If the requirement can be met and there are idle bandwidth units, the AP can serve as a seller AP. If the requirement cannot be met, the AP can serve as a purchaser AP.

As an example, assuming that the number of terminals within the coverage of the purchaser AP is N_{c}, the spectrum bandwidth of one communication resource unit is W, and the number of terminals that can be supported by one communication resource unit is N₁, and assuming the number of spectrum bandwidth units that the AP already has is xₒ, so the number x_{b} of spectral bandwidth units that the purchaser AP needs to purchase is shown in formula (1).

$${x}_{b} = ⌈ \frac{{N}_{c}}{{N}_{1}} ⌉ - {x}_{o} \qquad ( 1 )$$

After the required amount of resources is determined, the electronic device will purchase resources from a specific number of neighboring electronic devices, where the neighboring electronic devices refer to electronic devices whose coverages intersect with that of the purchaser AP. According to an embodiment of the present disclosure, the specific number is determined based on the amount of wireless communication resources to be purchased. As an example, the specific number may depend on the number of spectral bandwidth units that the electronic device needs to purchase, as described above.

As an example, assuming that the purchaser AP can only purchase at most one bandwidth unit from one seller AP, the number of seller APs is equal to the determined number of spectrum bandwidth units to be purchased, for example, the purchaser AP needs to purchase spectrum resources from x_{b} seller APs. As another example, if it is allowed to purchase multiple (for example, D) bandwidth units from a seller AP, the seller AP can be virtualized, for example, one seller AP can be virtualized into multiple virtual seller APs, and one bandwidth unit can be purchased from each virtual seller AP. In this case, the actual seller AP may be x_{b}/D. Of course, the number of seller APs can also be determined based on the number of spectrum bandwidth units required to be purchased in various appropriate ways, which will not be described in detail here.

The specific number of neighboring electronic devices can be set in various ways. According to an embodiment of the present disclosure, preferably, the specific number of neighboring electronic devices may be specified according to intersection conditions of coverages. The coverage intersection conditions of neighboring electronic devices, such as the intersection area, can be determined when the communication system is established and broadcast to each device in the system, or can also be calculated when the devices in the system need to purchase or sell communication resources.

The intersection area of the communication coverage can be determined in various ways. In particular, the intersection area can be determined based on the size s (for example, can be represented by radius) of the respective coverages of the two APs and the distance between the two APs. According to an embodiment of the present disclosure, the communication coverage intersection area Sc between an electronic device and a neighboring electronic device is as follows:

$$α = arccos ( \frac{{R}_{b}^{2} + {d}_{b s}^{2} - {R}_{s}^{2}}{2 {R}_{b} {d}_{bs}} ) \qquad ( 2 )$$

$$β = arccos ( \frac{{R}_{s}^{2} + {d}_{b s}^{2} - {R}_{b}^{2}}{2 {R}_{s} {d}_{b s}} ) \qquad ( 3 )$$

$${S}_{c} = {R}_{s}^{2} ( β - sin β cos β ) + {R}_{b}^{2} ( α - sin αcosα ) \qquad ( 4 )$$

Wherein, d_{bs} indicates the distance between the electronic device and the neighboring electronic device; R_{b} indicates the radius of the communication coverage of the electronic device, and Rₛ indicates the radius of the communication coverage of the neighboring electronic device.

FIG. 4 shows a schematic diagram of determining an exemplary intersection area between a purchaser AP and a seller AP according to an embodiment of the present disclosure. Among them, AP_{b} is the purchaser AP, and APₛ is the seller AP. Assuming that the coverages of purchaser AP and seller AP are in shapes of circles, and the radii are Rb and Rs respectively. According to the cosines law, the radians of α and β in FIG. 4 are calculated respectively, as shown in formulas (2) and (3), and then the coverage intersection area Sc can be calculated as shown in formula (4).

In particular, the seller APₛ may be one of at least one seller AP whose coverages intersect with the coverage of the purchaser AP_{b}. Therefore, the intersection area between the purchaser AP_{b} and each seller AP may be calculated according to the above calculation method. As an example, assuming that the set of seller APs whose coverages intersect with the coverage of purchaser APb is {s₁, . . . , sᵢ, . . . , s_{M}}, M can be determined based on the aforementioned x_{b}, for example, M=x_{b} when only one bandwidth unit can be purchased from a seller AP, or M=x_{b}/D in a case where a plurality of bandwidth units can be purchased from one seller AP. The purchaser AP_{b} obtains the geographic locations of these seller APs, and calculates the distance dbₛⱼ therebetween, j is randomly selected from a set {1, . . . , M}, and thus the intersection area with each seller AP can be calculated.

According to an embodiment of the present disclosure, the specific number of neighboring electronic devices can be the top specific number of neighboring electronic devices in the at least one neighboring electronic device ranked by communication coverage intersection areas from large to small.

After determining the specific number of neighboring electronic devices as seller APs, the electronic device as a purchaser AP can bid to each neighboring electronic device as the seller AP, so as to request to purchase corresponding communication resources. According to an embodiment of the present disclosure, for the specific number of neighboring electronic devices, a purchase bid to each neighboring electronic device is sequentially made in the order of the sizes of the communication coverage intersection areas therebetween.

According to an embodiment of the present disclosure, the bid by the electronic device to a neighboring electronic device for purchasing communication resources therefrom is based on the coverage intersection area therebetween, and generally, the larger the coverage intersection area is, the higher the bid is. In particular, the reason why the purchaser AP purchases spectrums from neighboring APs is due to the interference caused by the neighboring APs using the spectrums, so that the bid actually belongs to a measure of the interference influence. That is, the larger the coverage interaction area between two Aps is, the higher the bid should be.

According to an embodiment of the present disclosure, the purchase bid of the electronic device to the neighboring electronic device may be a random bid depending on the size of the communication coverage intersection area between it and the neighboring electronic device. Random bid can avoid the interference of artificial price setting and improve fairness. In particular, in a case that more than one purchaser APs purchases resources from the seller AP, random bid can improve the fairness of each purchaser AP obtaining corresponding spectrum resources from the seller AP.

According to an embodiment of the present disclosure, the random bid complies with a Gaussian distribution, wherein the mean value of the Gaussian distribution is proportional to the communication coverage intersection area. In this way, the random bid employed by the purchaser AP to each seller AP complies with the Gaussian distribution, meanwhile, the present disclosure only determines the mean and variance of the Gaussian distribution, while the actual bid is a random variable, which ensures fairness and suppresses interference. At the same time, the determination of the mean value of the Gaussian distribution depends on the coverage intersection area, which increases the diversity between APs to a certain extent.

In addition, according to an embodiment of the present disclosure, the sum of the purchase bids of the electronic device to the specific number of neighboring electronic devices is less than a specific constraint value. The specific constraint value may be set in any suitable manner and set to any suitable value. As an example, resource transactions according to the present disclosure can be carried out by means of so-called resource coins, such as bidding and transaction in units of resource coins, each resource coin can correspond to each unit of resource, which is expressed as a basic value, so that the specific constraint value is also related to the resource coins, which can be the whole of resource coins owned by the electronic device before the transaction or a specific proportion thereof. As an example, the resource coins owned by the electronic device can be set to an initial value at the beginning of establishment of the communication system, and may change dynamically in each transaction due to bidding for or selling of resources. It should be noted that resource coins are exemplary expressions only used to describe resource transactions more clearly, they are only used to indicate the price paid for obtaining resources, and they essentially are only numerical values.

Purchaser APs will obtain the same amount of Spectrum Coins at the initial stage. Usually, the purchaser AP will bid to multiple seller APs, and the sum of the bids needs to be less than the total number of spectrum coins that the AP currently has.

As an example, when a purchaser AP bids for resources from a set of seller APs containing at least one seller AP, the coverage intersection area Sc between the purchaser AP and each AP in the set of seller APs is calculated respectively, and the seller APs are ranked based on the value of Sc from large to small, the top xb seller Aps are selected as transaction targets. Assuming that the bids are: y1, . . . , yxb.

Here, yj complies with a Gaussian distributed φ(zj, a2), where zj is the mean value of yj, a2 is the variance. Moreover, the size of zj is proportional to the size of Sc, as shown in formula (5).

$$\frac{{z}_{1}}{{S}_{c 1}} = \frac{{z}_{2}}{{S}_{c 2}} = … = \frac{{z}_{x b}}{{S}_{cxb}} \qquad ( 5 )$$

At the same time, assuming that the number of spectrum coins that AP currently owns is Cr, it is necessary to constrain the total bid to be less than the total amount of owned spectrum coins, as shown in formula (6).

y₁+y₂+ . . . +y_{xb}≤Cᵣ (6)

Under these constraints, the purchaser AP can sequentially make random bids conforming to the Gaussian distribution to the seller APs in a serial manner, that is, sequentially bids in order of the intersection area from large to small.

Thus, the electronic device on the resource purchase side can purchase resources from neighboring electronic devices in the communication system, so as to meet its own communication requirement.

In the structural example of the above device, the processing circuit may be in the form of a general-purpose processor, or may be a dedicated processing circuit, such as an ASIC. For example, the processing circuit can be configured by a circuit (hardware) or a central processing device such as a central processing unit (CPU). In addition, the processing circuit may carry a program (software) for operating the circuit (hardware) or the central processing device. The program can be stored in a memory (such as arranged in the memory) or an external storage medium connected from the outside, and downloaded via a network (such as the Internet).

According to one embodiment, the processing circuit 302 may include various units for realizing the above functions, such as determination unit 304 configured to determine a specific number of neighboring electronic devices in the at least one neighboring electronic device for purchasing wireless communication resources therefrom; and purchase unit 306 configured to purchase wireless communication resources from the specific number of neighboring electronic devices on the basis of the sizes of the communication coverage intersection areas between the electronic device and the specific number of neighboring electronic devices.

The above units can operate as described above, and will not be described in detail here. It should be noted that each of the above units only belongs to a logical module classified according to the specific function it implements, instead of limiting its specific implementation manner, for example, it can be implemented in software, hardware, or a combination of software and hardware. In an actual implementation, the foregoing units may be implemented as separate physical entities, or may be implemented by a single entity (for example, a processor (CPU or DSP, etc.), an integrated circuit, etc.). Note that although each unit is shown as a separate unit in FIG. 3, one or more of these units may be combined into one unit or split into multiple units. Furthermore, that the foregoing units are indicated by dotted lines in the FIG. indicates that the foregoing units may not actually exist, and the operation/functionality they achieve can be implemented by the processing circuit itself.

It should be understood that FIG. 3 is only a schematic structural configuration of the purchase side electronic device, and alternatively, the purchase side electronic device 300 may also include other components not shown, such as a memory, a radio frequency link, a baseband processing unit, a network interface, a controller, and the like. The processing circuit may be associated with a memory and/or an antenna. For example, the processing circuit can be directly or indirectly connected to the memory (for example, other components may be interposed therebetween) to access data. The memory can store various kinds of information (e.g., vehicle internal state information and its analysis result, etc.) acquired and generated by the processing circuit 302, programs and data for the operation of the terminal-side electronic device, data to be transmitted by the terminal-side electronic device, etc. The memory can also be located in the terminal-side electronic device but outside the processing circuit, or even outside the terminal-side electronic device. The memory can be volatile memory and/or nonvolatile memory. For example, the memory may include, but is not limited to, random access memory (RAM), dynamic random access memory (DRAM), static random access memory (SRAM), read only memory (ROM) and flash memory.

For example, the processing circuit can be directly or indirectly connected to the antenna to send information and receive requests/instructions via the transmission unit. For example, as an example, the antenna may be an omni-directional antenna and/or a directional antenna, which may be implemented in various ways, such as an antenna array (such as both omni-directional antenna and directional antenna, or a single antenna array capable of realizing the functions of both omni-directional antenna and directional antenna) and/or a radio frequency link, which will not be described in detail here. As an example, the antenna may also be included in the processing circuit or external to the processing circuit. It can even be coupled/attached to the electronic device 300 without being included in the electronic device 300.

Resource Sale

An exemplary electronic device in a wireless communication system for selling wireless communication resources according to an embodiment of the present disclosure will be described below. FIG. 5 shows an exemplary electronic device 500 in the wireless communication system for selling wireless communication resources according to an embodiment of the present disclosure, the electronic device for selling wireless communication resources hays an associated communication coverage.

The electronic device 500 includes a processing circuit 502 configured to receive bids from at least one neighboring electronic device for wireless communication resources of the electronic device, at least one neighboring electronic device having communication coverage intersecting with that of the electronic device; and select a specific electronic device in the at least one neighboring electronic device for selling wireless communication resources thereto.

According to an embodiment of the present disclosure, a specific electronic device may be selected for transaction based on the bids of the electronic device for purchasing resources. Here, the neighboring electronic device that bids is the purchaser AP as mentioned above, and its bidding can be that as above, and will not be described in detail here.

A seller AP usually receives bids from multiple purchaser APs, and it is necessary to select an AP from these bidding APs as the transaction object. According to the present disclosure, various methods can be used to determine the purchaser AP as the transaction object.

According to an embodiment of the present disclosure, a neighboring electronic device among the at least one neighboring electronic device with the highest bid may be selected as the specific electronic device for transaction. As an example, the seller AP usually receives bids from multiple purchaser APs, and among them, the purchaser AP with the highest bid is directly selected as the transaction object, so as to maximize the benefit.

According to an embodiment of the present disclosure, among the at least one neighboring electronic device, a neighboring electronic device with the highest bid within a specific price range may be selected as the specific electronic device.

In particular, in order to avoid unreasonable bidding by some purchaser APs, which will cause greater interference to the purchase fairness, a reasonable price range can be preset to filter the bids of all purchaser APs, and keep the purchaser APs within the price range, and select the AP with the highest bid therefrom. If no AP's bid is in this range, the idle spectrum resources will not be traded. In this way, each purchaser AP can be guided to make more reasonable bid, while improving fairness, and excessive bids will be invalidated.

This price range can be set in various appropriate ways.

According to an embodiment of the present disclosure, the specific price range is determined based on coverage intersection areas of the electronic device and all neighboring electronic devices whose coverages intersect with that of the electronic device.

According to an embodiment of the present disclosure, the specific price range can be determined by: determining an average value of the coverage intersection areas with all neighboring electronic devices; determining a first ratio based on a maximum value among coverage intersection areas with all neighboring electronic devices and the average value; determining a second ratio based on a minimum value among coverage intersection areas with all neighboring electronic devices and the average value; determining an average value of bids from at least one neighboring electronic device; and multiplying the average value of bids by the first ratio and the second ratio respectively to serve as limit values of the specific price range.

As an example, the seller AP first obtains the geographic locations of all APs whose coverages intersect with that of the seller AP, and calculates the intersection area with each AP accordingly. Then, the maximum value Smax and the minimum value Smin of the intersection area can be selected from all the calculated intersection areas, and the average Saver of all the intersection areas can be used for normalization to obtain two ratio values λₘₐₓ=Smax/Saver, λₘᵢₙ=Smin/Saver. Meanwhile, the seller AP calculates an average value yaver based on the sum of bids received, and then multiplies it by λmax and λmin respectively, to obtain an appropriate price range [ymax, ymin], where ymax=yaver×λmax, ymin=yaver×λmin.

According to an embodiment of the present disclosure, after the transaction object is determined, transaction information including the sale price and information about neighboring electronic devices that participate in the transaction is notified to the neighboring electronic device and an accounting electronid device in the wireless communication system, for being processed by the accounting electronid device.

Similar to that for the electronic device used at the resource purchase end as discussed above, the processing circuit of the electronic device at the resource sale end, and thereby the electronic device at the resource sale end, can also be implemented in various appropriate forms as mentioned above, which will be no describe here in detail.

In particular, according to an embodiment, the processing circuit 502 may include various units for correspondingly implementing the above operations, for example, the electronic device includes reception unit 504 configured to receive bids from at least one neighboring electronic device for wireless communication resources of the electronic device, at least one neighboring electronic device having communication coverage intersecting with that of the electronic device; and selection unit 506 configured to select a specific electronic device in the at least one neighboring electronic device for selling wireless communication resources thereto.

According to one embodiment, the processing circuit further includes a transmission unit 508 configured to transmit transaction information including the sale price and information about a neighboring electronic device that participate in the transaction to the neighboring electronic device and an accounting electronid device in the wireless communication system.

In addition, similar to the contents for the electronic device at the resource purchase end as described above, the structure/composition of the above-mentioned electronic device at the resource purchase end is only exemplary.

It should be noted that the above-mentioned units each only belongs to a logical module classified according to the specific function it implements, instead of limiting its specific implementation manner, which is similar to the description for the resource purchase side and will not be described in detail here. In addition, similar to the description for the resource purchase side, the electronic device on the resource sale side may also include additional or supplementary units/devices, such as memory, communication interface, etc., which will not be described in detail here.

The operation of transaction confirmation according to the embodiment of the present disclosure will be described below.

According to an embodiment of the present disclosure, based on the blockchain technology, the seller AP will send, after determination of the transaction, the information related to the transaction to the accounting electronic device in the wireless communication system, and the accounting electronic device can be configured in any appropriate way, as mentioned above, it will not be described in detail here.

In particular, the accounting electronic device may be an electronic device at the resource purchase end or an electronic device at the resource sale end. In this case, the processing circuit of the electronic device at the resource purchase end or the electronic device at the resource sale end as the accounting electronic device will also perform the following operations: summarizing information related to all transactions, and then packaging the transaction information into unauthenticated blocks which will be sent to each node for authentication.

According to an embodiment of the present disclosure, after the authentication result is fed back by each node to the accounting electronic device, the accounting electronic device will determine the legal transaction according to rules, and write the legal transaction into a new block, so as to send it to each node for recording. In particular, for a transaction, the accounting electronic device will approve it, and write relevant information of the transaction into a new block under the condition that the transaction is approved to be valid (that is, it can be considered as a legal transaction). In this case, the processing circuit of the electronic device at the resource purchase end or the electronic device at the resource sale end as the accounting electronic device will also perform the following operations: conducting transaction approval based on the feedback information from the relevant electronic device about transaction authentication, and writing information about the transaction which is approved valid into a new block so as to be sent to each electronic device in the system.

According to one implementation, the processing circuit of the electronic device at the resource purchase end or the electronic device at the resource sale end as the accounting electronic device may include an accounting unit which is configured to summarize information related to all transactions, and then package the transaction information into unauthenticated blocks. The receiving of transaction-related information and the sending of unauthenticated blocks can be performed through the receiving unit and sending unit of the electronic device, or through other suitable communication interfaces. According to another implementation, the accounting unit may also conduct transaction approval based on the feedback information about transaction authentication from the relevant electronic device, and write information about the transaction which is approved valid into a new block. Here, the receiving of the feedback information and the sending of the new block can be performed through the receiving unit and sending unit of the electronic device, or through other suitable communication interfaces. As an example, the electronic device 300 at the resource purchase end may optionally include an accounting unit 308, and/or the electronic device 500 at the resource sale end may optionally include an accounting unit 510, of course, this accounting unit is optional, and it may be included in the processing circuit or even outside the processing circuit. It should be noted that the generation of the authentication block and the generation of the new block may be performed by a single authentication unit as described above, or alternatively by two separate units, which will not be described in detail here.

According to the embodiments of the present disclosure, either the electronic device at the resource purchase end or the electronic device at the resource sale end may participate in transaction authentication. In this case, the processing circuit of the electronic device at the resource purchase end or the electronic device at the resource sale end will also perform the following operations: receiving the authentication block from the accounting electronic device in the wireless communication system, the block includes communication resource transaction information to be authenticated; authenticating the authentication block, and sending the authentication result to the accounting electronic device.

As an example, for resource transactions, the electronic device at the resource purchase end or the electronic device at the resource sale end may perform transaction authentication in different manners, according to the degree of its association with the resource transaction, as mentioned above, which will not be described in detail here.

According to one implementation, the processing circuit of the electronic device at the resource purchase end or the resource sale end of the accounting electronic device may include an authentication unit which is configured to authenticate the authentication block received from the accounting electronic device in the wireless communication system, the block includes communication resource transaction information to be authenticated. The receiving of the block to be authenticated and the sending of the authentication information may be performed by the receiving unit and sending unit of the electronic device, or may be performed by other suitable communication interfaces. As an example, the electronic device 300 at the resource purchase end may optionally include an authentication unit 310, and/or the electronic device 500 at the resource sale end may optionally include an authentication unit 512, of course, this authentication unit is optional, and it may be included in the processing circuit, or it can also be even outside the processing circuit.

According to the embodiments of the present disclosure, after the resource transaction is approved, either the electronic device at the resource purchase end or the electronic device at the resource sale end can receive the information about the approved communication resource transaction. In this case, the processing circuit of the electronic device at the resource purchase end or the electronic device at the resource sale end is further configured to receive a block from the accounting electronic device in the wireless communication system, the block including the information about the approved communication resources transaction.

According to one implementation, the receiving of the block may be performed by a receiving unit of the electronic device, or may be performed through other suitable communication interfaces/communication units.

Each of the above units can operate as described above, which will not be described in detail here. It should be noted that the above-mentioned units are only logical modules classified according to the specific functions they implement, and are not used to limit their specific implementation manners, and will not be described in detail here. It should be noted that the above-mentioned accounting unit, authentication unit, etc. are optional, and are shown by dotted lines in the drawings.

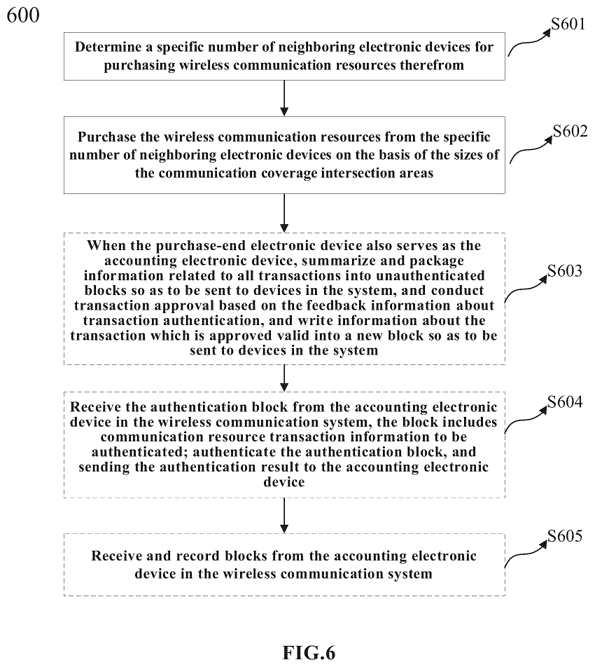

A method for a purchase end in a wireless communication system according to an embodiment of the present disclosure will be described below with reference to the accompanying drawings. FIG. 6 shows a flow chart of a method 600 for a purchase end in a wireless communication system according to an embodiment of the present disclosure.

In step S601, a specific number of neighboring electronic devices in the at least one neighboring electronic device are determined for purchasing wireless communication resources therefrom.

In step S602, the wireless communication resources are purchased from the specific number of neighboring electronic devices on the basis of the sizes of the communication coverage intersection areas between the electronic device and the specific number of neighboring electronic device.

Furthermore, the method may also include corresponding steps for implementing the above-mentioned operations performed by the electronic device at the purchase end, specifically step S604 of performing an authentication operation and step S605 of receiving confirmation information after the transaction is completed. In addition, if the purchase end is to be used as an electronic accounting device, the method for the purchase end will also include step S603 of performing the above-mentioned accounting operation, which will not be described again here. It should be noted that depending on the role and functionality of the electronic device in the transaction process, steps S603 to S605 are optional, so they are indicated by dotted lines in the figure.

It should be noted that these steps can be performed by the aforementioned electronic device at the purchase end according to the present disclosure, especially by corresponding units of the aforementioned electronic device at the purchase end according to the present disclosure.

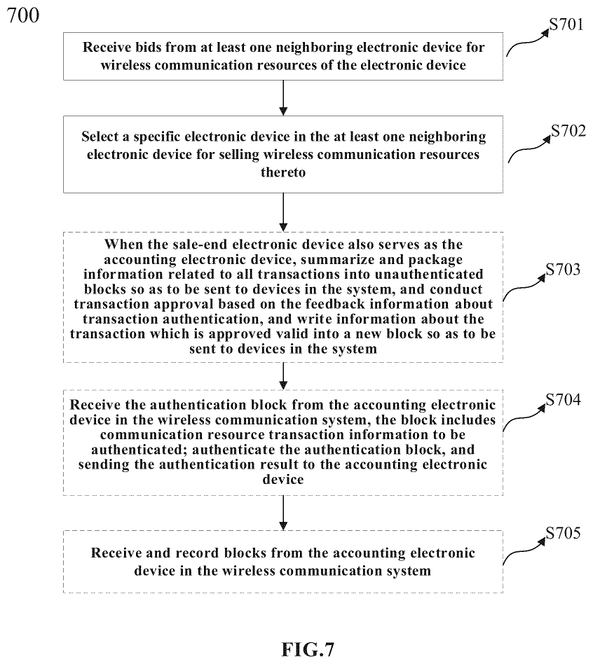

A method for a resource sale end of a wireless communication system according to an embodiment of the present disclosure will be described below with reference to the accompanying drawings. FIG. 7 shows a flowchart of a method 700 for the resource sale end of the wireless communication system resources according to an embodiment of the present disclosure.

In step S701, bids are received from at least one neighboring electronic device for wireless communication resources of the electronic device, at least one neighboring electronic device having communication coverage intersecting with that of the electronic device.

In step S702, a specific electronic device in the at least one neighboring electronic device, to which wireless communication resources will be sold, is selected.

Furthermore, the method may also include corresponding steps for realizing the above-mentioned operations performed by the sale end electronic device, specifically step S704 of performing an authentication operation and step S705 of receiving confirmation information after the transaction is completed. In addition, if the sale end is to be used as an electronic accounting device, the method for the sale end will also include step S703 of performing the aforementioned accounting operation, which will not be described again here. It should be noted that depending on the role and functionality of the electronic device in the transaction process, steps S703 to S705 are optional, so they are indicated by dotted lines in the figure.

It should be noted that these steps can be performed by the aforementioned electronic device at the sale end according to the present disclosure, especially by corresponding units of the aforementioned electronic device at the sale end according to the present disclosure.

This disclosure proposes to use the blockchain technology to realize communication resource management in a communication system, especially to realize dynamic management and allocation of resources among devices in a wireless communication system, thereby optimizing resource utilization efficiency, and improve security.

According to the present disclosure, the AP can adjust the sale and purchase status of its own spectrum resources in real time, based on the number of terminals that need to be served within its coverage or the communication requirements. On the one hand, it will help meet the requirements of users within the coverage, and on the other hand, it will help improve overall service satisfaction degree in the system scenario.

Furthermore, according to the present disclosure, the purchaser AP adopts a method based on coverage intersection area to help determine the purchase price, the method fully considers that the essence of purchasing the spectrum resources is to eliminate the interference influence on the purchaser AP when the seller AP uses the spectrum.

In addition, according to the present disclosure, the interaction of transaction information and control information between APs can be implemented in various ways, which increases the compatibility of the method and facilitates selection of a corresponding method according to actual network condition.

In addition, according to the present disclosure, the seller AP selects the purchaser AP with the highest bid in a specific price range, which is beneficial to guide the purchaser AP to make a reasonable bid, and increase the fairness for the purchaser AP to obtain spectrum resources. Meanwhile, choosing the highest price is also beneficial to the seller AP to obtain better rewards.

### Specific Example

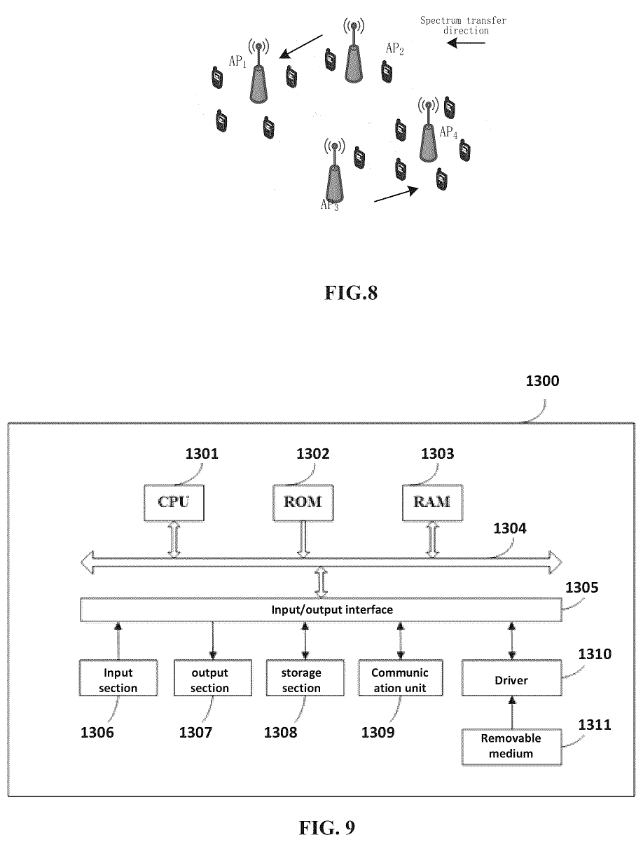

Usually, in addition to the common cellular network, sometimes some enterprises or factories will establish some private networks for simpler and customized communication. The frequency bands used by these networks may be unlicensed frequency bands, or shared frequency bands that do not interfere with primary users, such as broadcast television white spectrum (TVWS) or CBRS frequency bands open in the United States. Assuming that these frequency bands are shared by multiple APs in a region, there will be a spectrum allocation problem among multiple APs. Here, the blockchain technology is utilized to realize the transaction of spectrum resources among APs. A specific embodiment scenario is shown in FIG. 8, and there are 4 APs in the scenario. Among them, AP1 and AP4 need to serve a large number of terminals, and AP2 and AP3 need to serve a small number of terminals. AP1 needs to purchase at most two bandwidth units from other APs, and here it can purchase spectrum resources from AP2 and AP3 respectively. AP4 needs to purchase at most two bandwidth units from other APs, and here it can purchase spectrum resources from AP2 and AP3 respectively. It can be seen from the figure that AP1 and AP2 have a larger coverage intersection area. According to the bidding rules of the present disclosure, the bid of AP1 will be more likely to be agreed by AP2. Similarly, AP3 and AP4 have a larger coverage intersection area, so the bid of AP4 is more likely to be agreed by AP3.

It should be noted that the above description is only exemplary. The disclosed embodiments can also be executed in any other appropriate way, and still achieve the advantageous effects obtained by the embodiments according to the present disclosure. Furthermore, the embodiments of the present disclosure can also be applied to other similar application instances, and the advantageous effects obtained by the embodiments of the present disclosure can still be achieved.

It should be understood that the machine-executable instructions in the machine-readable storage medium or program product according to the embodiments of the present disclosure may be configured to perform operations corresponding to the above-mentioned device and method embodiments. When referring to the above device and method embodiments, the embodiments of the machine-readable storage medium or program product are clear to those skilled in the art, and therefore will not be described repeatedly. Machine-readable storage medium and program products for carrying or including the above-mentioned machine-executable instructions also fall within the scope of the present disclosure. Such a storage medium may include, but is not limited to, a floppy disk, an optical disk, a magneto-optical disk, a memory vehicled, a memory stick, and the like.

In addition, it should be understood that the processes and devices described above may also be implemented by software and/or firmware. When implemented by software and/or firmware, a program constituting the software is installed from a storage medium or a network to a computer having a dedicated hardware structure, such as a general-purpose personal computer 1300 shown in FIG. 9, and the computer can perform a variety of functions by installing various programs thereon. FIG. 9 is a block diagram illustrating an example structure of a personal computer as an information processing apparatus that can be adopted in an embodiment of the present disclosure. In one example, the personal computer may correspond to the above-described exemplary transmitting device or terminal-side electronic device according to the present disclosure.

In FIG. 9, a central processing unit (CPU) 1301 performs various processes according to a program stored in a read only memory (ROM) 1302 or a program loaded from a storage section 1308 to a random-access memory (RAM) 1303. In the RAM 1303, data required when the CPU 1301 executes various processes and the like is also stored as necessary.

The CPU 1301, the ROM 1302, and the RAM 1303 are connected to each other via a bus 1304. An input/output interface 1305 is also connected to the bus 1304.

The following components are connected to the input/output interface 1305: an input section 1306 including a keyboard, a mouse, etc.; an output section 1307 including a display, such as a cathode ray tube (CRT), a liquid crystal display (LCD), etc., and a speaker, etc.; a storage section 1308 including hard disks, etc.; and communication section 1309 including network interface vehicleds such as LAN vehicleds, modems, etc. The communication section 1309 performs communication processing via a network such as the Internet.

A driver 1310 is also connected to the input/output interface 1305 as needed. A removable medium 1311 such as a magnetic disk, an optical disk, a magneto-optical disk, a semiconductor memory, etc. is installed on the drive 1310 as needed, so that a computer program read out therefrom can be installed into the storage section 1308 as needed.

In a case where the above-mentioned processes are realized by a software, the programs constituting the software are installed from a network such as the Internet or a storage medium such as a removable medium 1311.

Those skilled in the art should understand that such a storage medium is not limited to the removable medium 1311 shown in FIG. 9 in which the program is stored and which is distributed separately from the device to provide the program to the user. Examples of the removable medium 1311 include a magnetic disk (including a floppy disk (registered trademark)), an optical disk (including a CD-ROM and a digital versatile disk (DVD)), and a magneto-optical disk (including a mini disk (MD) (registered trademark))) and semiconductor memory. Alternatively, the storage medium may be the ROM 1302, a hard disk included in the storage section 1308, and the like, in which programs are stored and which are distributed to users along with the device containing them.

The technology of the present disclosure can be applied to various products.

For example, the control-side electronic devices according to embodiments of the present disclosure can be implemented as a variety of control devices/base stations, or be included therein. For example, the transmitting-side electronic device and/or terminal electronic device according to embodiments of the present disclosure can be implemented as a variety of terminal devices or be included in a variety of terminal devices.

For example, the transmitting-side electronic device/base stations mentioned in this disclosure can be implemented as any type of base station, for example, evolved Node B (eNB), such as macro eNB and small eNB. A small eNB may be an eNB covering a cell smaller than a macro cell, such as a pico eNB, a micro eNB, and a home (femto) eNB. Furthermore, for example, the transmitting-side electronic device/base stations can be implemented as gNB, such as macro gNB and small gNB. A small gNB may be a gNB covering a cell smaller than a macro cell, such as a pico gNB, a micro gNB, and a home (femto) gNB. Alternatively, the base station can be implemented as any other type of base station, such as a NodeB and a Base Transceiver Station (BTS). The base station may include: a main body (also referred to as a base station device) configured to control wireless communication; and one or more remote radio heads (RRHs) disposed at a place different from the main body. In addition, various types of terminals described below can work as base stations by temporarily or semi-persistently performing base station functions.

For example, in some embodiments, the terminal device mentioned in this disclosure can be implemented as a mobile terminal such as a smart phone, a tablet personal computer (PC), a notebook PC, a portable gaming terminal, a portable/dongle Mobile routers and digital cameras, or vehicle terminals such as vehicle navigation equipment. The terminal device can also be implemented as a terminal that performs machine-to-machine (M2M) communication, also called as a machine type communication (MTC) terminal. In addition, the terminal device may be a wireless communication module mounted on each of the terminals described above, such as an integrated circuit module including a single chip.

Examples according to the present disclosure will be described below with reference to the figures.

### Example of Base Station

It should be understood that the term “base station” in this disclosure has the full breadth of its usual meaning and includes at least a wireless communication station that is used as part of a wireless communication system or radio system for communication. Examples of base stations may be, for example but not limited to, the following: maybe one or both of a base transceiver station (BTS) and a base station controller (BSC) in a GSM system, may be one or both of a radio network controller (RNC) and Node B in a WCDMA system, may be eNBs in LTE and LTE-Advanced systems, or may be corresponding network nodes in future communication systems (such as gNB, eLTE eNB, etc that may appear in 5G communication systems). Part of the functions in the base station of the present disclosure can also be implemented as an entity with control function for communication in D2D, M2M, and V2V communication scenarios, or as an entity that plays a spectrum coordination role in cognitive radio communication scenarios.

### First Example

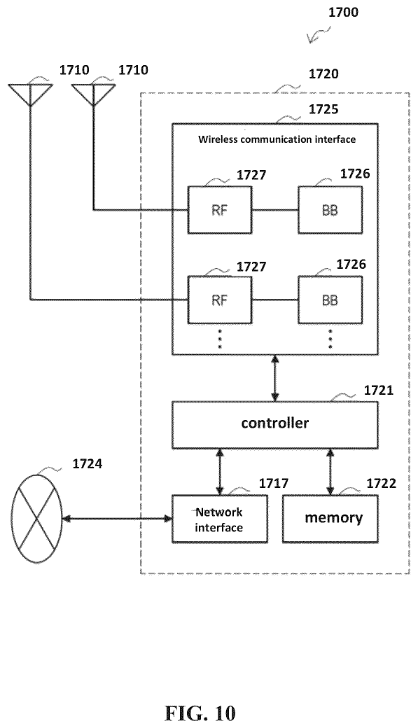

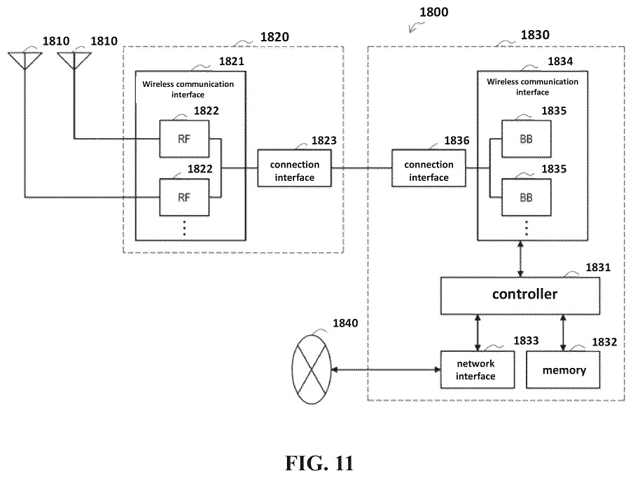

FIG. 10 is a block diagram illustrating a first example of a schematic configuration of a gNB to which the technology of the present disclosure can be applied. The gNB 1700 includes a plurality of antennas 1710 and a base station device 1720. The base station device 1720 and each antenna 1710 may be connected to each other via an RF cable. In an implementation manner, the gNB 1700 (or the base station device 1720) herein may correspond to the above-mentioned transmitting-side and/or receiving-side electronic device.

Each of the antennas 1710 includes a single or multiple antenna elements, such as multiple antenna elements included in a multiple-input multiple-output (MIMO) antenna, and is used for the base station device 1720 to transmit and receive wireless signals. As shown in FIG. 10, the gNB 1700 may include a plurality of antennas 1710. For example, multiple antennas 1710 may be compatible with multiple frequency bands used by gNB 1700.

The base station device 1720 includes a controller 1721, a memory 1722, a network interface 1717, and a wireless communication interface 1725.

The controller 1721 may be, for example, a CPU or a DSP, and operates various functions of the base station device 1720 at a higher layer. For example, the controller 1721 determines position information about a target terminal device in at least one terminal device on the terminal side of a wireless communication system based on the location information and specific position configuration information about the at least one terminal device acquired via a wireless communication interface 1725. The controller 1721 may have logical functions that perform controls such as radio resource control, radio bearer control, mobility management, admission control, and scheduling. The controls can be performed in conjunction with a nearby gNB or core network node. The memory 1722 includes a RAM and a ROM, and stores a program executed by the controller 1721 and various types of control data such as a terminal list, transmission power data, and scheduling data.

The network interface 1717 is a communication interface for connecting the base station device 1720 to the core network 1724. The controller 1721 may communicate with a core network node or another gNB via the network interface 1717. In this case, the gNB 1700 and the core network node or other gNBs may be connected to each other through a logical interface such as an S1 interface and an X2 interface. The network interface 1717 may also be a wired communication interface or a wireless communication interface for a wireless backhaul line. If the network interface 1717 is a wireless communication interface, compared with the frequency band used by the wireless communication interface 1725, the network interface 1717 can use a higher frequency band for wireless communication.

The wireless communication interface 1725 supports any cellular communication scheme such as Long Term Evolution (LTE) and LTE-Advanced, and provides a wireless connection to a terminal located in a cell of the gNB 1700 via an antenna 1710. The wireless communication interface 1725 may generally include, for example, a baseband (BB) processor 1726 and an RF circuit 1727. The BB processor 1726 may perform, for example, encoding/decoding, modulation/demodulation, and multiplexing/demultiplexing, and execute various types of signal processing in layers such as L1, Medium Access Control (MAC), Radio Link Control (RLC), and Group Data Convergence Protocol (PDCP). As an alternative of the controller 1721, the BB processor 1726 may have a part or all of the above-mentioned logical functions. The BB processor 1726 may be a memory storing a communication control program, or a module including a processor and related circuits configured to execute the program. Updating the program can change the function of the BB processor 1726. The module may be a vehicled or a blade inserted into a slot of the base station device 1720. Alternatively, the module may be a chip mounted on a vehicled or a blade. Meanwhile, the RF circuit 1727 may include, for example, a mixer, a filter, and an amplifier, and transmits and receives a wireless signal via the antenna 1710. Although FIG. 10 illustrates an example in which one RF circuit 1727 is connected to one antenna 1710, the present disclosure is not limited to this illustration, but one RF circuit 1727 may be connected to multiple antennas 1710 at the same time.

As shown in FIG. 10, the wireless communication interface 1725 may include a plurality of BB processors 1726. For example, the plurality of BB processors 1726 may be compatible with multiple frequency bands used by gNB 1700. As shown in FIG. 10, the wireless communication interface 1725 may include a plurality of RF circuits 1727. For example, the plurality of RF circuits 1727 may be compatible with multiple antenna elements. Although FIG. 10 illustrates an example in which the wireless communication interface 1725 includes a plurality of BB processors 1726 and a plurality of RF circuits 1727, the wireless communication interface 1725 may also include a single BB processor 1726 or a single RF circuit 1727.

### Second Example

FIG. 11 is a block diagram illustrating a second example of a schematic configuration of a gNB to which the technology of the present disclosure can be applied. The gNB 1800 includes multiple antennas 1810, RRH 1820 and base station equipment 1830. The RRH 1820 and each antenna 1810 may be connected to each other via an RF cable. The base station equipment 1830 and the RRH 1820 may be connected to each other via a high-speed line such as a fiber optic cable. In an implementation manner, the gNB 1800 (or the base station equipment 1830) herein may correspond to the foregoing transmitting-side and/or receiving-side electronic device.

Each of the antennas 1810 includes a single or multiple antenna elements (such as multiple antenna elements included in a MIMO antenna) and is used for RRH 1820 to transmit and receive wireless signals. As shown in FIG. 11, the gNB 1800 may include multiple antennas 1810. For example, multiple antennas 1810 may be compatible with multiple frequency bands used by gNB 1800.

The base station device 1830 includes a controller 1831, a memory 1832, a network interface 1833, a wireless communication interface 1834, and a connection interface 1836. The controller 1831, the memory 1832, and the network interface 1833 are the same as the controller 1721, the memory 1722, and the network interface 1717 described with reference to FIG. 10.

The wireless communication interface 1834 supports any cellular communication scheme such as LTE and LTE-Advanced, and provides wireless communication to a terminal located in a sector corresponding to the RRH 1820 via the RRH 1820 and the antenna 1810. The wireless communication interface 1834 may typically include, for example, a BB processor 1835. The BB processor 1835 is the same as the BB processor 1726 described with reference to FIG. 10 except that the BB processor 1835 is connected to the RF circuit 1822 of the RRH 1820 via the connection interface 1836. As shown in FIG. 11, the wireless communication interface 1834 may include a plurality of BB processors 1835. For example, multiple BB processors 1835 may be compatible with multiple frequency bands used by gNB 1800. Although FIG. 11 illustrates an example in which the wireless communication interface 1834 includes a plurality of BB processors 1835, the wireless communication interface 1834 may also include a single BB processor 1835.

The connection interface 1836 is an interface for connecting the base station device 1830 (wireless communication interface 1834) to the RRH 1820. The connection interface 1836 may also be a communication module for communication in the above-mentioned high-speed line connecting the base station device 1830 (wireless communication interface 1834) to the RRH 1820.

The RRH 1820 includes a connection interface 1823 and a wireless communication interface 1821.

The connection interface 1823 is an interface for connecting the RRH 1820 (wireless communication interface 1821) to the base station device 1830. The connection interface 1823 may also be a communication module for communication in the above-mentioned high-speed line.

The wireless communication interface 1821 transmits and receives wireless signals via the antenna 1810. The wireless communication interface 1821 may generally include, for example, an RF circuit 1822. The RF circuit 1822 may include, for example, a mixer, a filter, and an amplifier, and transmits and receives wireless signals via the antenna 1810. Although FIG. 11 illustrates an example in which one RF circuit 1822 is connected to one antenna 1810, the present disclosure is not limited to this illustration, but one RF circuit 1822 may be connected to multiple antennas 1810 at the same time.

As shown in FIG. 11, the wireless communication interface 1821 may include a plurality of RF circuits 1822. For example, the plurality of RF circuits 1822 may support multiple antenna elements. Although FIG. 11 illustrates an example in which the wireless communication interface 1821 includes a plurality of RF circuits 1822, the wireless communication interface 1821 may include a single RF circuit 1822.

### Example of User Device/Terminal Device

### First Example

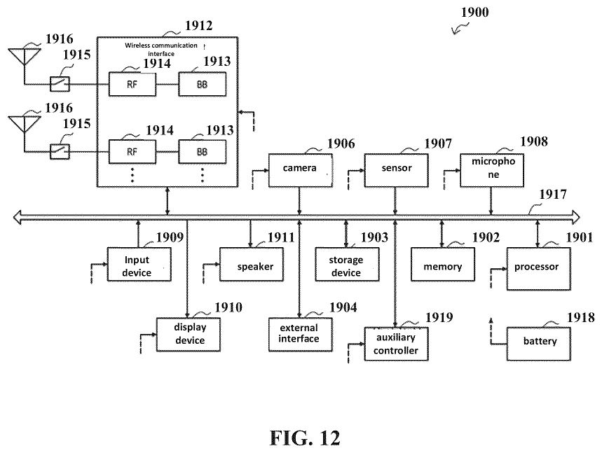

FIG. 12 is a block diagram illustrating an example of a schematic configuration of a communication device 1900, such as smartphone, linker, etc., to which the technology of the present disclosure can be applied. The communication device 1900 includes a processor 1901, a memory 1902, a storage device 1903, an external connection interface 1904, a camera device 1906, a sensor 1907, a microphone 1908, an input device 1909, a display device 1910, a speaker 1911, a wireless communication interface 1912, one or more antenna switches 1915, one or more antennas 1916, a bus 1917, a battery 1918, and an auxiliary controller 1919. In an implementation manner, the communication device 1900 (or the processor 1901) herein may correspond to the foregoing transmitting device or terminal-side electronic device.

The processor 1901 may be, for example, a CPU or a system on chip (SoC), and controls functions of an application layer and another layer of the smartphone 1900. The memory 1902 includes a RAM and a ROM, and stores data and programs executed by the processor 1901. The storage device 1903 may include a storage medium such as a semiconductor memory and a hard disk. The external connection interface 1904 is an interface for connecting external devices such as a memory vehicled and a universal serial bus (USB) device to the smartphone 1900.

The camera device 1906 includes an image sensor such as a charge-coupled device (CCD) and a complementary metal oxide semiconductor (CMOS), and generates a captured image. The sensor 1907 may include a set of sensors such as a measurement sensor, a gyroscope sensor, a geomagnetic sensor, and an acceleration sensor. The microphone 1908 converts a sound input to the smartphone 1900 into an audio signal. The input device 1909 includes, for example, a touch sensor, a keypad, a keyboard, a button, or a switch configured to detect a touch on the screen of the display device 1910, and receives an operation or information input from a user. The display device 1910 includes a screen such as a liquid crystal display (LCD) and an organic light emitting diode (OLED) display, and displays an output image of the smartphone 1900. The speaker 1911 converts an audio signal output from the smartphone 1900 into a sound.

The wireless communication interface 1912 supports any cellular communication scheme such as LTE and LTE-Advanced, and performs wireless communication. The wireless communication interface 1912 may generally include, for example, a BB processor 1913 and an RF circuit 1914. The BB processor 1913 may perform, for example, encoding/decoding, modulation/demodulation, and multiplexing/demultiplexing, and perform various types of signal processing for wireless communication. Meanwhile, the RF circuit 1914 may include, for example, a mixer, a filter, and an amplifier, and transmits and receives wireless signals via the antenna 1916. The wireless communication interface 1912 may be a chip module on which a BB processor 1913 and an RF circuit 1914 are integrated. As shown in FIG. 12, the wireless communication interface 1912 may include multiple BB processors 1913 and multiple RF circuits 1914. Although FIG. 12 illustrates an example in which the wireless communication interface 1912 includes a plurality of BB processors 1913 and a plurality of RF circuits 1914, the wireless communication interface 1912 may also include a single BB processor 1913 or a single RF circuit 1914.

In addition, in addition to the cellular communication scheme, the wireless communication interface 1912 may support other types of wireless communication scheme, such as a short-range wireless communication scheme, a near field communication scheme, and a wireless local area network (LAN) scheme. In this case, the wireless communication interface 1912 may include a BB processor 1913 and an RF circuit 1914 for each wireless communication scheme.

Each of the antenna switches 1915 switches a connection destination of the antenna 1916 between a plurality of circuits included in the wireless communication interface 1912 (for example, circuits for different wireless communication schemes).

Each of the antennas 1916 includes a single or multiple antenna elements, such as multiple antenna elements included in a MIMO antenna, and is used for the wireless communication interface 1912 to transmit and receive wireless signals. As shown in FIG. 12, the smartphone 1900 may include a plurality of antennas 1916. Although FIG. 12 illustrates an example in which the smart phone 1900 includes a plurality of antennas 1916, the smart phone 1900 may also include a single antenna 1916.

In addition, the smartphone 1900 may include an antenna 1916 for each wireless communication scheme. In this case, the antenna switch 1915 may be omitted from the configuration of the smartphone 1900.

The bus 1917 connects the processor 1901, the memory 1902, the storage device 1903, the external connection interface 1904, the camera device 1906, the sensor 1907, the microphone 1908, the input device 1909, the display device 1910, the speaker 1911, the wireless communication interface 1912, and the auxiliary controller 1919 to each other. The battery 1918 supplies power to each block of the smartphone 1900 shown in FIG. 12 via a feeder, and the feeder is partially shown as a dotted line in the figure. The auxiliary controller 1919 operates the minimum necessary functions of the smartphone 1900 in the sleep mode, for example.

### Second Example

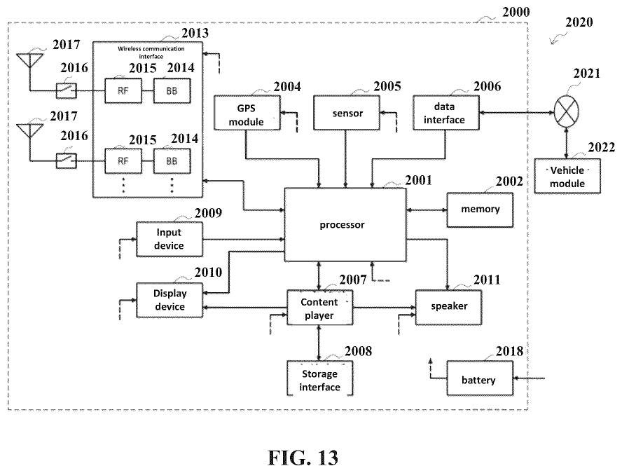

FIG. 13 is a block diagram illustrating an example of a schematic configuration of a vehicle navigation device 2000 to which the technology of the present disclosure can be applied. The vehicle navigation device 2000 includes a processor 2001, a memory 2002, a global location system (GPS) module 2004, a sensor 2005, a data interface 2006, a content player 2007, a storage medium interface 2008, an input device 2009, a display device 2010, a speaker 2011, and a wireless communication interface 2013, one or more antenna switches 2016, one or more antennas 2017, and a battery 2018. In an implementation manner, the vehicle navigation device 2000 (or the processor 2001) herein may correspond to the transmitting device or terminal-side electronic device.

The processor 2001 may be, for example, a CPU or a SoC, and controls navigation functions and other functions of the vehicle navigation device 2000. The memory 2002 includes a RAM and a ROM, and stores data and programs executed by the processor 2001.

The GPS module 2004 uses a GPS signal received from a GPS satellite to measure the position (such as latitude, longitude, and altitude) of the vehicle navigation device 2000. The sensor 2005 may include a set of sensors such as a gyroscope sensor, a geomagnetic sensor, and an air pressure sensor. The data interface 2006 is connected to, for example, an in-vehicle network 2021 via a terminal not shown, and acquires data (such as vehicle speed data) generated by the vehicle.

The content player 2007 reproduces content stored in a storage medium such as a CD and a DVD, which is inserted into the storage medium interface 2008. The input device 2009 includes, for example, a touch sensor, a button, or a switch configured to detect a touch on the screen of the display device 2010, and receives an operation or information input from a user. The display device 2010 includes a screen such as an LCD or OLED display, and displays an image of a navigation function or reproduced content. The speaker 2011 outputs the sound of the navigation function or the reproduced content.

The wireless communication interface 2013 supports any cellular communication scheme such as LTE and LTE-Advanced, and performs wireless communication. The wireless communication interface 2013 may generally include, for example, a BB processor 2014 and an RF circuit 2015. The BB processor 2014 may perform, for example, encoding/decoding, modulation/demodulation, and multiplexing/demultiplexing, and perform various types of signal processing for wireless communication. Meanwhile, the RF circuit 2015 may include, for example, a mixer, a filter, and an amplifier, and transmit and receive wireless signals via the antenna 2017. The wireless communication interface 2013 may also be a chip module on which a BB processor 2014 and an RF circuit 2015 are integrated. As shown in FIG. 13, the wireless communication interface 2013 may include a plurality of BB processors 2014 and a plurality of RF circuits 2015. Although FIG. 13 illustrates an example in which the wireless communication interface 2013 includes a plurality of BB processors 2014 and a plurality of RF circuits 2015, the wireless communication interface 2013 may also include a single BB processor 2014 or a single RF circuit 2015.

In addition, in addition to the cellular communication scheme, the wireless communication interface 2013 may support other types of wireless communication scheme, such as a short-range wireless communication scheme, a near field communication scheme, and a wireless LAN scheme. In this case, the wireless communication interface 2013 may include a BB processor 2014 and an RF circuit 2015 for each wireless communication scheme.

Each of the antenna switches 2016 switches the connection destination of the antenna 2017 between a plurality of circuits included in the wireless communication interface 2013, such as circuits for different wireless communication schemes.

Each of the antennas 2017 includes a single or multiple antenna element, such as multiple antenna elements included in a MIMO antenna, and is used for the wireless communication interface 2013 to transmit and receive wireless signals. As shown in FIG. 13, the vehicle navigation device 2000 may include a plurality of antennas 2017. Although FIG. 13 illustrates an example in which the vehicle navigation device 2000 includes a plurality of antennas 2017, the vehicle navigation device 2000 may also include a single antenna 2017.

In addition, the vehicle navigation device 2000 may include an antenna 2017 for each wireless communication scheme. In this case, the antenna switch 2016 may be omitted from the configuration of the vehicle navigation device 2000.

The battery 2018 supplies power to each block of the vehicle navigation device 2000 shown in FIG. 13 via a feeder, and the feeder is partially shown as a dotted line in the figure. The battery 2018 accumulates power provided from the vehicle.

The technology of the present disclosure may also be implemented as a vehicle on-board system (or vehicle) 2020 including one or more of a vehicle navigation device 2000, an in-vehicle network 2021, and a vehicle module 2022. The vehicle module 2022 generates vehicle data such as vehicle speed, engine speed, and failure information, and outputs the generated data to the in-vehicle network 2021.

The exemplary embodiments of the present disclosure have been described above with reference to the drawings, but the present disclosure is of course not limited to the above examples. Those skilled in the art may find various alternations and modifications within the scope of the appended claims, and it should be understood that they will naturally fall in the technical scope of the present disclosure.

It should be understood that the machine-executable instructions in the machine-readable storage medium or program product according to the embodiments of the present disclosure may be configured to perform operations corresponding to the above-mentioned device and method embodiments. When referring to the above device and method embodiments, the embodiments of the machine-readable storage medium or program product are clear to those skilled in the art, and therefore will not be described repeatedly. Machine-readable storage medium and program products for carrying or including the above-mentioned machine-executable instructions also fall within the scope of the present disclosure. Such a storage medium may include, but is not limited to, a floppy disk, an optical disk, a magneto-optical disk, a memory card, a memory stick, and the like.

In addition, it should be understood that the processes and devices described above may also be implemented by software and/or firmware. In the case of implementation by software and/or firmware, corresponding programs constituting the corresponding software are stored in the storage medium of the related device, and the programs, when executed, can perform various functions.

For example, a plurality of functions included in one unit in the above embodiment can be realized by separate devices. Alternatively, a plurality of functions included in one unit in the above embodiments may be respectively realized by separate devices. In addition, one of the above functions can be realized by multiple units, and such a configuration is also included in the technical scope of this disclosure.

In this specification, the steps described in the flowchart include not only the processes that are executed in time series in the stated order, but also the processes that are executed in parallel or solely instead of necessarily in time series. In addition, even in the step of processing in time series, needless to say, the order can be appropriately changed.

In addition, the method and system of the present invention can be implemented in various ways. For example, the method and system of the present invention can be implemented by software, hardware, firmware or any combination thereof. The above-described sequence of steps of the method is only illustrative, and the steps of the method of the present invention are not limited to the above-described sequence unless otherwise specifically stated. Furthermore, in some embodiments, the present invention can also be embodied as a program recorded in a recording medium, including machine-readable instructions for implementing the method according to the present invention. Therefore, the present invention also covers a recording medium storing a program for implementing the method according to the present invention. Such storage media may include, but are not limited to, floppy disks, optical disks, magneto-optical disks, memory cards, memory sticks, etc.

Those skilled in the art should realize that the boundaries between the above operations are only illustrative. Multiple operations can be combined into a single operation, which can be distributed among additional operations, and the operations can be performed at least partially intersecting in time. Furthermore, alternative embodiments may include multiple instances of specific operations, and the order of operations may be changed in other various embodiments. However, other modifications, changes and substitutions are also possible. Therefore, the description and drawings should be regarded as illustrative rather than restrictive.

Moreover, the embodiments of the present application can also include the following exemplary embodiments (EE).
EE 1. An electronic device in a wireless communication system for purchasing wireless communication resources, the electronic device has an associated communication coverage which intersects with the communication coverage of at least one neighboring electronic device, the electronic device comprises a processing circuit configured to:
determine a specific number of neighboring electronic devices in the at least one neighboring electronic device for purchasing wireless communication resources therefrom; and
purchase wireless communication resources from the specific number of neighboring electronic devices on the basis of sizes of the communication coverage intersection areas between the electronic device and the specific number of neighboring electronic devices.
EE 2. The electronic device of EE 1, wherein the amount of wireless communication resources to be purchased depends on communication requirements within a coverage region of the electronic device.
EE 3. The electronic device of EE 1, wherein the specific number is determined based on the amount of wireless communication resources to be purchased.
EE 4. The electronic device of EE 1, wherein the specific number of neighboring electronic devices are the top specific number of neighboring electronic devices in the at least one neighboring electronic device ranked by communication coverage intersection areas from large to small.
EE 5. The electronic device of EE 1, wherein the processing circuit is configured to, for the specific number of neighboring electronic devices, sequentially make a purchase bid to each neighboring electronic device in the order of the sizes of communication coverage intersection areas.
EE 6. The electronic device of EE 5, wherein, for each of the specific number of neighboring electronic devices, the purchase bid from the electronic device is a random bid depending on the size of communication coverage intersection area between the electronic device and the neighboring electronic device.
EE 7. The electronic device of EE 6, wherein the random bid complies with a Gaussian distribution, wherein the expectation value of the Gaussian distribution is proportional to the communication coverage intersection area.
EE 8. The electronic device of any one of EEs 1-7, wherein the communication coverage intersection area Sc between the electronic device and the neighboring electronic device is as follows:

$$α = arccos ( \frac{{R}_{b}^{2} + {d}_{b s}^{2} - {R}_{s}^{2}}{2 {R}_{b} {d}_{bs}} )$$

$$β = arccos ( \frac{{R}_{s}^{2} + {d}_{b s}^{2} - {R}_{b}^{2}}{2 {R}_{s} {d}_{b s}} )$$

$${S}_{c} = {R}_{s}^{2} ( β - sin β cos β ) + {R}_{b}^{2} ( α - sin αcosα )$$

wherein, d_{bs} indicates the distance between the electronic device and the neighboring electronic device; R_{b} indicates the radius of the communication coverage of the electronic device, and Rₛ indicates the radius of the communication coverage of the neighboring electronic device.
EE 9. The electronic device of EE 1, wherein a sum of purchase bids from the electronic device for the specific number of neighboring electronic devices is smaller than a specific constraint value.
EE 10. The electronic device of EE 1, wherein the processing circuit is further configured to:
receive an authentication block from an accounting electronic device in the wireless communication system, wherein the authentication block comprises information about a communication resource transaction to be authenticated;
authenticate the authentication block, and
send the authentication result to the accounting electronic device.
EE 11. The electronic device of EE 1, wherein the processing circuit is further configured to:
receive a block from an accounting electronic device in the wireless communication system, the block including information about an approved communication resource transaction.
EE 12. An electronic device in a wireless communication system for selling wireless communication resources, the electronic device has an associated communication coverage, the electronic device includes a processing circuit configured to:
receive bids from at least one neighboring electronic device for wireless communication resources of the electronic device, at least one neighboring electronic device having communication coverages intersecting with that of the electronic device; and
select a specific electronic device in the at least one neighboring electronic device for selling wireless communication resources thereto.
EE 13. The electronic device of EE 12, wherein the processing circuit is configured to select one of the at least one neighboring electronic device with highest bid as the specific electronic device.
EE 14. The electronic device of EE 12, wherein the processing circuit is configured to select one of the at least one neighboring electronic device with highest bid in a specific price range as the specific electronic device.
EE 15. The electronic device of EE 14, wherein the specific price range is determined based on coverage intersection areas of the electronic device and all neighboring electronic devices whose coverages intersect with that of the electronic device.
EE 16. The electronic device of EE 15, wherein the specific price range is determined by:
determining an average value of the coverage intersection areas between the electronic device and all neighboring electronic devices;
determining a first ratio based on a maximum value among coverage intersection areas between the electronic device and all neighboring electronic devices and the average value;
determining a second ratio based on a minimum value among coverage intersection areas between the electronic device and all neighboring electronic devices and the average value;
determining an average value of bids from the at least one neighboring electronic device; and
multiplying the average value of bids by the first ratio and the second ratio respectively to serve as limit values of the specific price range.
EE 17. The electronic device of EE 12, wherein the processing circuit is configured to notify a neighboring electronic device that participate in the transaction and an accounting electronic device in the wireless communication system of transaction information including the sale price and information about the neighboring electronic device.
EE 18. The electronic device of EE 12, wherein the processing circuit is configured to:
receive an authentication block from an accounting electronic device in the wireless communication system, wherein the authentication block comprises information about a communication resource transaction to be authenticated;
authenticate the authentication block, and
send the authentication result to the accounting electronic device.
EE 19. The electronic device of EE 12, wherein the processing circuit is further configured to:
receive a block from an accounting electronic device in the wireless communication system, the block including information about an approved communication resource transaction.
EE 20. The electronic device of EE 12, wherein the electronic device, the neighboring electronic devices, and the accounting electronic device communicate through a public network.
EE 21. The electronic device of EE 12, wherein the electronic device, the neighboring electronic devices, and the accounting electronic device communicate through an ad hoc network.
EE 22. A method for an electronic device in a wireless communication system for purchasing wireless communication resources, the electronic device has an associated communication coverage which intersects with the communication coverage of at least one neighboring electronic device, and the method comprises:
determining a specific number of neighboring electronic devices in the at least one neighboring electronic device for purchasing wireless communication resources therefrom; and
purchasing wireless communication resources from the specific number of neighboring electronic devices on the basis of the sizes of communication coverage intersection areas between the electronic device and the at least one neighboring electronic device.
EE 23. The method of EE 22, wherein the amount of wireless communication resources to be purchased depends on communication requirements within a coverage region of the electronic device.
EE 24. The method of EE 22, wherein the specific number is determined based on the amount of wireless communication resources to be purchased.
EE 25. The method of EE 22, wherein the specific number of neighboring electronic devices are the top specific number of neighboring electronic devices in the at least one neighboring electronic device ranked by communication coverage intersection areas from large to small.
EE 26. The method of EE 22, wherein the method further comprises, for the specific number of neighboring electronic devices, sequentially making a purchase bid to each neighboring electronic device in the order of the sizes of the communication coverage intersection areas.
EE 27. The method of EE 26, wherein, for each of the specific number of neighboring electronic devices, the purchase bid is a random bid depending on the size of communication coverage intersection area between the electronic device and the neighboring electronic device.
EE 28. The method of EE 27, wherein the random bid complies with a Gaussian distribution, and wherein the expectation value of the Gaussian distribution is proportional to the communication coverage intersection area.
EE 29. The method of any one of EEs 22-28, wherein the communication coverage intersection area Sc between the electronic device and the neighboring electronic device is as follows:

$$α = arccos ( \frac{{R}_{b}^{2} + {d}_{b s}^{2} - {R}_{s}^{2}}{2 {R}_{b} {d}_{bs}} )$$

$$β = arccos ( \frac{{R}_{s}^{2} + {d}_{b s}^{2} - {R}_{b}^{2}}{2 {R}_{s} {d}_{b s}} )$$

$${S}_{c} = {R}_{s}^{2} ( β - sin β cos β ) + {R}_{b}^{2} ( α - sin αcosα )$$

wherein, d_{bs} indicates the distance between the electronic device and the neighboring electronic device; R_{b} indicates the radius of the communication coverage of the electronic device, and Rₛ indicates the radius of the communication coverage of the neighboring electronic device.
EE 30. The method of EE 22, wherein a sum of purchase bids from the electronic device for the specific number of neighboring electronic devices is smaller than a specific constraint value.
EE 31. The method of EE 22, wherein the method further comprises:
receiving an authentication block from an accounting electronic device in the wireless communication system, wherein the authentication block comprises information about a communication resource transaction to be authenticated;
authenticating the authentication block, and
sending the authentication result to the accounting electronic device.
EE 32. The method of EE 22, wherein the method further comprises:
receiving a block from an accounting electronic device in the wireless communication system, the block including information about an approved communication resource transaction.
EE 33. A method for an electronic device in a wireless communication system for selling wireless communication resources, the electronic device has an associated communication coverage, and the method comprises:
receiving bids from at least one neighboring electronic device for wireless communication resources of the electronic device, at least one neighboring electronic device having communication coverage intersecting with that of the electronic device; and
selecting a specific electronic device in the at least one neighboring electronic device for selling wireless communication resources thereto.
EE 34. The method of EE 33, further comprising selecting one of the at least one neighboring electronic device with highest bid as the specific electronic device.
EE 35. The method of EE 34, further comprising selecting one of the at least one neighboring electronic device with highest bid in a specific price range as the specific electronic device.
EE 36. The method of EE 35, wherein the specific price range is determined based on coverage intersection areas of the electronic device and all neighboring electronic devices whose coverages intersect with that of the electronic device.
EE 37. The method of EE 36, wherein the specific price range is determined by: determining an average value of the coverage intersection areas between the electronic device and all neighboring electronic devices;
determining a first ratio based on a maximum value among coverage intersection areas between the electronic device and all neighboring electronic devices and the average value;
determining a second ratio based on a minimum value among coverage intersection areas between the electronic device and all neighboring electronic devices and the average value;
determining an average value of bids from the at least one neighboring electronic device; and
multiplying the average value of bids by the first ratio and the second ratio respectively to serve as limit values of the specific price range.
EE 38. The method of EE 33, further comprising notifying the neighboring electronic device that participate in the transaction and an accounting electronid device in the wireless communication system of transaction information including the sale price and information about the neighboring electronic device.
EE 39. The method of EE 33, further comprising:
receiving an authentication block from an accounting electronic device in the wireless communication system, wherein the authentication block comprises information about a communication resource transaction to be authenticated;
authenticate the authentication block, and
send the authentication result to the accounting electronic device.
EE 40. The method of EE 33, further comprising:
receiving a block from an accounting electronic device in the wireless communication system, the block including information about an approved communication resource transaction.
EE 41. The method of EE 33, wherein the electronic device, the neighboring electronic devices, and the accounting electronic device communicate through a public network.
EE 42. The method of EE 33, wherein the electronic device, the neighboring electronic devices, and the accounting electronic device communicate through an ad hoc network.
EE 43. A device comprising
at least one processor; and
at least one storage device that stores instructions thereon that, when executed by the at least one processor, cause the at least one processor to execute the method of any one of EEs 22 to 42.
EE 44. A storage medium storing instructions which, when executed by a processor, cause execution of the method of any one of EEs 22 to 42.
EE 45. An apparatus comprising means for performing the method of any one of EEs 22 to 42.

Although the present disclosure and its advantages have been described in detail, it should be understood that various changes, substitutions and alterations can be made hereto without departing from the spirit and scope of the present disclosure as defined by the appended claims. Furthermore, the terms “including”, “comprising”, or any other variation thereof, of the embodiments of the present disclosure are intended to encompass non-exclusive inclusion, such that a process, method, article, or device that includes a series of elements includes not only those elements, but also includes other elements not explicitly listed, or those inherent in the process, method, article, or equipment. Without more restrictions, the elements defined by the sentence “including a . . . ” do not exclude the existence of other identical elements in the process, method, article, or equipment including the elements.

Although some specific embodiments of the present disclosure have been described in detail, those skilled in the art should understand that the above-described embodiments are merely illustrative and do not limit the scope of the present disclosure. Those skilled in the art should understand that the above-described embodiments may be combined, modified, or replaced without departing from the scope and essence of the present disclosure. The scope of the present disclosure is defined by the appended claims.

1. An electronic device in a wireless communication system for purchasing wireless communication resources, the electronic device has an associated communication coverage which intersects with the communication coverage of at least one neighboring electronic device, the electronic device comprises a processing circuit configured to:
determine a specific number of neighboring electronic devices in the at least one neighboring electronic device for purchasing wireless communication resources therefrom; and
purchase wireless communication resources from the specific number of neighboring electronic devices on the basis of sizes of the communication coverage intersection areas between the electronic device and the specific number of neighboring electronic devices.

2. The electronic device of claim 1, wherein the amount of wireless communication resources to be purchased depends on communication requirements within a coverage region of the electronic device.

3. The electronic device of claim 1, wherein the specific number is determined based on the amount of wireless communication resources to be purchased.

4. The electronic device of claim 1, wherein the specific number of neighboring electronic devices are the top specific number of neighboring electronic devices in the at least one neighboring electronic device ranked by communication coverage intersection areas from large to small.

5. The electronic device of claim 1, wherein the processing circuit is configured to, for the specific number of neighboring electronic devices, make a purchase bid to each neighboring electronic device,
wherein the purchase bid from the electronic device is a random bid depending on the size of communication coverage intersection area between the electronic device and the neighboring electronic device.

6. (canceled)

7. The electronic device of claim 1, wherein the random bid complies with a Gaussian distribution, wherein the expectation value of the Gaussian distribution is proportional to the communication coverage intersection area.

8. (canceled)

9. The electronic device of claim 1, wherein a sum of purchase bids from the electronic device for the specific number of neighboring electronic devices is smaller than a specific constraint value.

10. The electronic device of claim 1, wherein the processing circuit is further configured to:
receive an authentication block from an accounting electronic device in the wireless communication system, wherein the authentication block comprises information about a communication resource transaction to be authenticated;
authenticate the authentication block, and
send the authentication result to the accounting electronic device.

11. The electronic device of claim 1, wherein the processing circuit is further configured to:
receive a block from an accounting electronic device in the wireless communication system, the block including information about an approved communication resource transaction.

12. An electronic device in a wireless communication system for selling wireless communication resources, the electronic device has an associated communication coverage, the electronic device includes a processing circuit configured to:
receive bids from at least one neighboring electronic device for wireless communication resources of the electronic device, at least one neighboring electronic device having communication coverages intersecting with that of the electronic device; and
select a specific electronic device in the at least one neighboring electronic device for selling wireless communication resources thereto.

13. (canceled)

14. The electronic device of claim 12, wherein the processing circuit is configured to select one of the at least one neighboring electronic device with highest bid in a specific price range as the specific electronic devices,
wherein the specific price range is determined based on coverage intersection areas of the electronic device and all neighboring electronic devices whose coverages intersect with that of the electronic device.

15. (canceled)

16. The electronic device of claim 14, wherein the specific price range is determined by:
determining an average value of the coverage intersection areas between the electronic device and all neighboring electronic devices;
determining a first ratio based on a maximum value among coverage intersection areas between the electronic device and all neighboring electronic devices and the average value;
determining a second ratio based on a minimum value among coverage intersection areas between the electronic device and all neighboring electronic devices and the average value;
determining an average value of bids from the at least one neighboring electronic device; and
multiplying the average value of bids by the first ratio and the second ratio respectively to serve as limit values of the specific price range.

17. The electronic device of claim 12, wherein the processing circuit is configured to notify a neighboring electronic device that participate in the transaction and an accounting electronic device in the wireless communication system of transaction information including the sale price and information about the neighboring electronic device.

18.-19. (canceled)

20. The electronic device of claim 12, wherein the electronic device, the neighboring electronic devices, and the accounting electronic device communicate through a public network and/or an ad hoc network.

21.-44. (canceled)

45. A non-transitory computer-readable storage medium storing executable instructions thereon,
wherein the executable instructions, when executed by a processor, cause the processor to purchase wireless communication resources for an electronic device in a wireless communication system which has an associated communication coverage that intersects with the communication coverage of at least one neighboring electronic device in the wireless system, by:
determining a specific number of neighboring electronic devices in the at least one neighboring electronic device for purchasing wireless communication resources therefrom; and
purchasing wireless communication resources from the specific number of neighboring electronic devices on the basis of sizes of the communication coverage intersection areas between the electronic device and the specific number of neighboring electronic devices, and/or
wherein the executable instructions, when executed by a processor, cause the processor to sell wireless communication resources of an electronic device in a wireless communication system that has an associated communication coverage, by
receiving bids from at least one neighboring electronic device for wireless communication resources of the electronic device, at least one neighboring electronic device having communication coverages intersecting with that of the electronic device; and
selecting a specific electronic device in the at least one neighboring electronic device for selling wireless communication resources thereto.

46. The non-transitory computer-readable storage medium of claim 45, wherein the executable instructions, when executed by a processor, cause the processor to purchase wireless communication resources for the electronic device by:
for the specific number of neighboring electronic devices, making a purchase bid to each neighboring electronic device, wherein the purchase bid from the electronic device is a random bid depending on the size of communication coverage intersection area between the electronic device and the neighboring electronic device.

47. The non-transitory computer-readable storage medium of claim 45, wherein the executable instructions, when executed by a processor, cause the processor to sell wireless communication resources of the electronic device by:
notifying a neighboring electronic device that participate in the transaction and an accounting electronic device in the wireless communication system of transaction information including the sale price and information about the neighboring electronic device.

48. The non-transitory computer-readable storage medium of claim 45, wherein the executable instructions, when executed by a processor, cause the processor to purchase wireless communication resources for the electronic device or sell wireless communication resources of the electronic device by:
receiving an authentication block from an accounting electronic device in the wireless communication system, wherein the authentication block comprises information about a communication resource transaction to be authenticated;
authenticating the authentication block, and
sending the authentication result to the accounting electronic device.

49. The non-transitory computer-readable storage medium of claim 45, wherein the executable instructions, when executed by a processor, cause the processor to purchase wireless communication resources for the electronic device or sell wireless communication resources of the electronic device by:
receiving a block from an accounting electronic device in the wireless communication system, the block including information about an approved communication resource transaction.

50. The non-transitory computer-readable storage medium of claim 45, wherein the electronic device, the neighboring electronic devices, and the accounting electronic device communicate through a public network and/or an ad hoc network.
